(19) United States
(12) Patent Application Publication
(10) Pub. No.: US 2016/0259841 A1
(43) Pub. Date: Sep. 8, 2016

(54) Research Analysis System

(71) Applicant: Tegu LLC, Tacoma, WA (US)

(72) Inventors: Crispin C. Andrew, Tacoma, WA (US); Hugh T. Winskill, Tacoma, WA (US)

(21) Appl. No.: 14/638,236

(22) Filed: Mar. 4, 2015

(51) Int. Cl. G06F 17/30; G06Q 50/16; G06N 5/02

(52) U.S. Cl. CPC G06F 17/30598; G06N 5/022; G06Q 50/16

(57) ABSTRACT

A research analysis system and method for providing reliable real estate information based on a given a set of criteria, such as an address, owner name, number of rental units, size, property type, and the like. In addition, the research analysis system is configured to provide enhanced real estate information to the real estate professional. The research analysis system aggregates data from various sources, performs comparisons on the aggregated data, and supplies the results of the comparisons to a classification tool whose output is used to create groupings of the data based on specific relationships and/or qualities of interest to the real estate industry, such as parcels having the same owner.

### FIELD OF THE INVENTION

The present invention relates to the field of online search and analysis, and more specifically, to the field of online real estate research and investigation.

### SUMMARY OF THE INVENTION WITH BACKGROUND INFORMATION

In the real estate industry, access to reliable and detailed property ownership information is incredibly important. A real estate professional needs to know details on real property and who owns real property (e.g., real estate, also referred to as “property”) in order to assist clients looking to buy, sell or lease such property. Real estate professionals also use ownership information to prospect for new clients, since current owners are a key source of future transactions, particularly in the commercial and investment property segments of the real estate industry.

Typically, when working on behalf of client to find property for sale or lease, the real estate professional determines the general requirements of the client (such as geographic area, size, and property type sought), and uses that criteria to assemble a list of candidate properties. As part of this process, ownership information is often taken into consideration, since various details of an owner, including the type and size of their holdings, can inform the likelihood of sale or otherwise impact the client. Ultimately, the list is used to contact the owners. Likewise, when working on behalf of an owner to sell a property, a real estate professional may contact owners of similar properties since owners of these similar properties may be likely buyers of the listed property.

When investigating ownership, the real estate professional may use information obtained from a county assessor's office and business information obtained from a state's secretary of state office. However, researching ownership of a particular property is time consuming and may not yield the desired information. Researching a large set of properties compounds the problem. The delay may result in a missed opportunity for the prospective client and the real estate professional. A real estate research tool that provides property ownership information for real estate professionals in a timely and reliable manner has eluded those skilled in the art.

Embodiments of the disclosure are directed towards a research analysis system and method for providing reliable real estate information based on a given a set of criteria, such as an address, owner name, number of rental units, size, property type (e.g., industrial, retail) and the like. In addition, the research analysis system is configured to provide enhanced real estate information to the real estate professional. The research analysis system aggregates data from various sources, performs comparisons on the aggregated data, and supplies the results of the comparisons to a classification tool whose output is used to create groupings of the data based on specific relationships and/or qualities of interest to the real estate industry, such as parcels having the same owner. The real estate information, enhanced real estate information, and/or groupings may be graphically depicted on a computing device in a manner to provide the real estate professional reliable information in a user-friendly and timely manner. The described system may be implemented in various industries in which there is a need to analyze large sets of disparate information and to determine relationships within the sets of information in a reliable and efficient manner and to provide enhanced information in a user-friendly manner.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a functional block diagram generally illustrating a system for researching and compiling related information about a subject of interest;

FIG. 2 is an exemplary graphical representation of a related grouping generated by the analysis engine illustrated in FIG. 1;

FIG. 3 is a system view of components for implementing at least one embodiment of the analysis engine in accordance with the present disclosure;

FIG. 4 is a flow diagram illustrating an exemplary process for determining related groupings that is performed by one or more of the components illustrated in FIG. 3;

FIG. 5 is a flow diagram illustrating an exemplary process for processing qualities suitable for use in the process illustrated in FIG. 4;

FIG. 6 is a flow diagram illustrating an exemplary process for processing relationships suitable for use in the process illustrated in FIG. 4;

FIG. 7 is a flow diagram illustrating an exemplary process for creating a datum suitable for use in the processes illustrated in FIGS. 5-6;

FIG. 8 is a flow diagram illustrating an exemplary process for determining related groupings suitable for use in the process illustrated in FIG. 4;

FIGS. 9A-9E are a series of exemplary graphs created during the processing illustrated in FIGS. 4-8;

FIG. 10 is a display illustrating an exemplary user interface for requesting related groupings from the analysis engine based on specified criteria and for displaying the related groupings in a graphical manner; and

FIG. 11 is a functional block diagram representing a computing device suitable for use in the research analysis system illustrated in FIG. 1.

### DETAILED DESCRIPTION OF THE PREFERRED EMBODIMENTS

Various embodiments will be described in detail with reference to the drawings, where like reference numerals represent like parts and assemblies throughout the several views. Many details of certain embodiments of the disclosure are set forth in the following description and accompanying figures so as to provide a thorough understanding of these embodiments. However, reference to the detail of these various embodiments does not limit the scope of the invention, which is limited only by the claims appended hereto. Additionally, any examples set forth in this specification are not intended to be limiting, but merely set forth some of the many possible ways of implementing the invention.

The following disclosure describes a system for researching, analyzing, and compiling related information about a subject of interest. For convenience, the system is described being implemented for the real estate industry. In this embodiment, the system provides reliable real estate information to a user (e.g., a real estate professional, an owner, an investor or other party) based on a set of requested criteria, such as an address, owner name, number of rental units, size, property type, or the like. In addition, in this embodiment, the system is configured to analyze the data based on relationships that are of interest in the real estate industry, such as determining parcels having the same owner. By analyzing the data based on pre-determined types of relationship, the system can provide enhanced real estate information to the user. The real estate information and enhanced real estate information may be graphically depicted on a map. It may also be presented through statistical analysis or provided as input to ancillary processes or consumers.

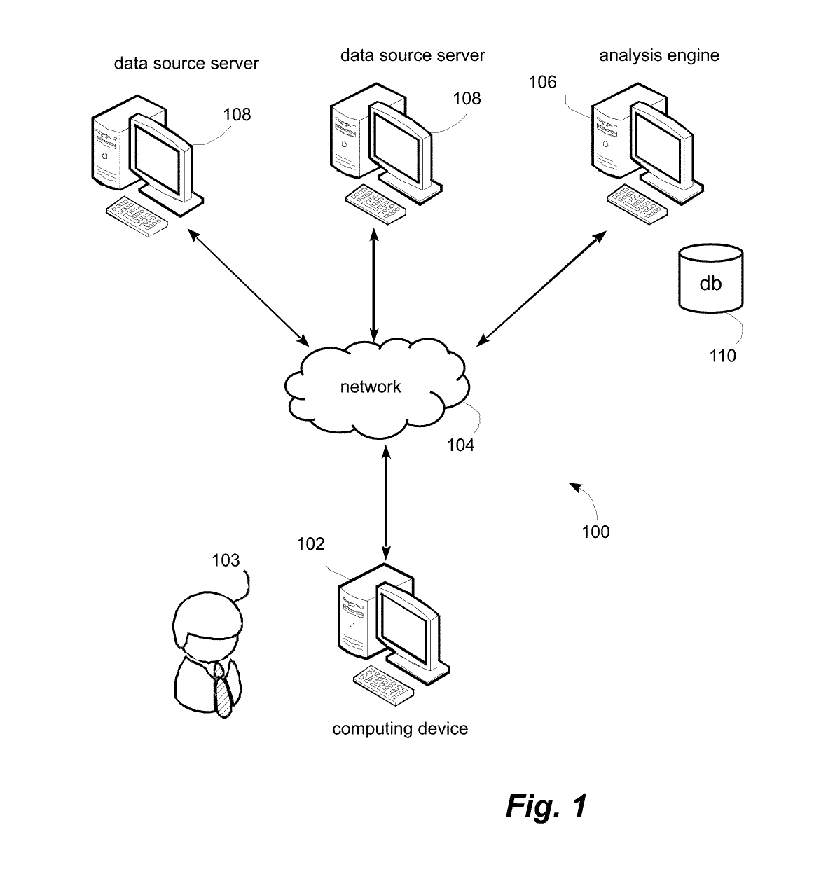

FIG. 1 is a functional overview of a system 100 in which embodiments of the invention may be implemented. The system 100 includes a user computing device 102, a network 104, an analysis engine 106, and one or more data source servers 108. A user 103 on computing device 102 may initiate a request over network 104 to the analysis engine 106 to obtain information related to the request. In the following discussion, the analysis engine is described in an embodiment in which the analysis engine is implemented to provide analysis of real estate information. For this embodiment, the analysis engine 106 may be interchangeably referred to as the real estate analysis engine. Those skilled in the art will appreciate that the concepts described below may also be implemented for other industries in addition to the real estate industry. These other industries will have their own relationships that are analyzed, but the underlying technique for analyzing the relationships and providing the results may use the techniques as described below.

In the real estate analysis engine embodiment, a request may be for information regarding a parcel and/or a request for other real estate related information. The real estate analysis engine 106 may maintain a database 110 in which pertinent real estate information is stored and accessed. The real estate information may include original data obtained from the one or more data source servers 108, may include data derived from the original data, may include data predicted from the original data, and/or may include data merged as one or more related groupings based on the predicted data. The data source servers 108 may provide real estate data from a county assessor's office, corporation data from a secretary of state's office, business and personal data from other sources, proprietary data prepared especially for the analysis engine, or the like. For example, personal data, such as records of deaths, may be obtained from a data source providing obituaries, which may be used to determine heirs. Other personal data may be obtained from Internet resources, such as social networking services.

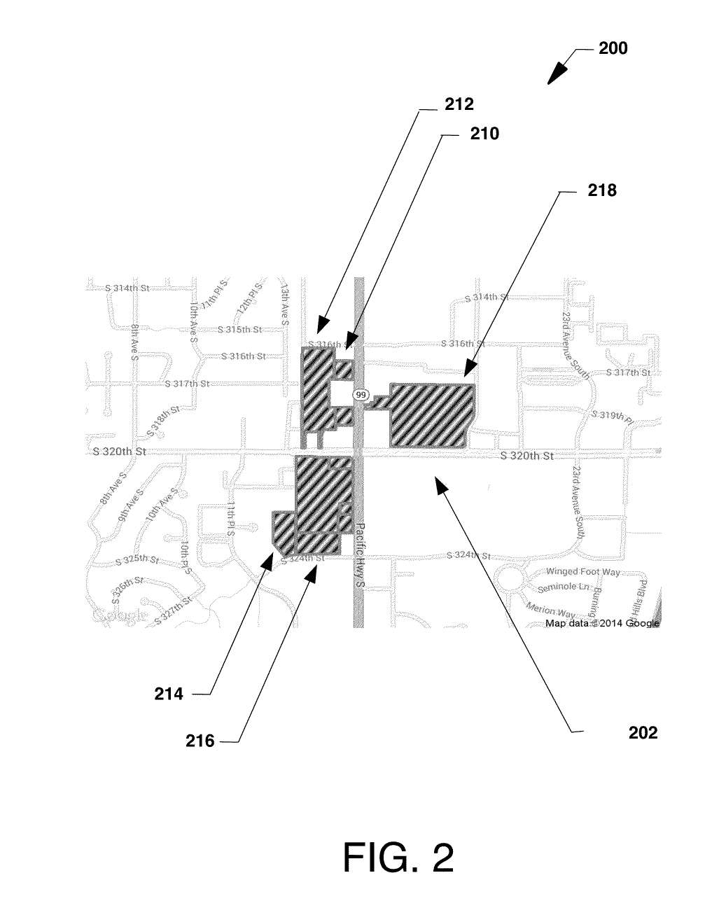

The real estate analysis engine 106 obtains data of interest from the data source servers 108 and analyzes the data to populate the database 110. The real estate analysis engine 106 is also configured to aggregate the information obtained from the data source servers 108 and to provide a representation of the information to computing device 102. In one embodiment, the aggregation of the information is represented graphically as a related grouping of data based on the requested criteria. For example, the real estate analysis engine 106 may create a grouping that includes parcels owned by the same owner in a given area (e.g., block, city, county, state, or the like). A graphical representation of the grouping may then be displayed on computing device 102 in response to the user's original request for information. An exemplary graphical representation of a related grouping for the real estate embodiment is illustrated in FIG. 2 and will be described below in conjunction with FIG. 2.

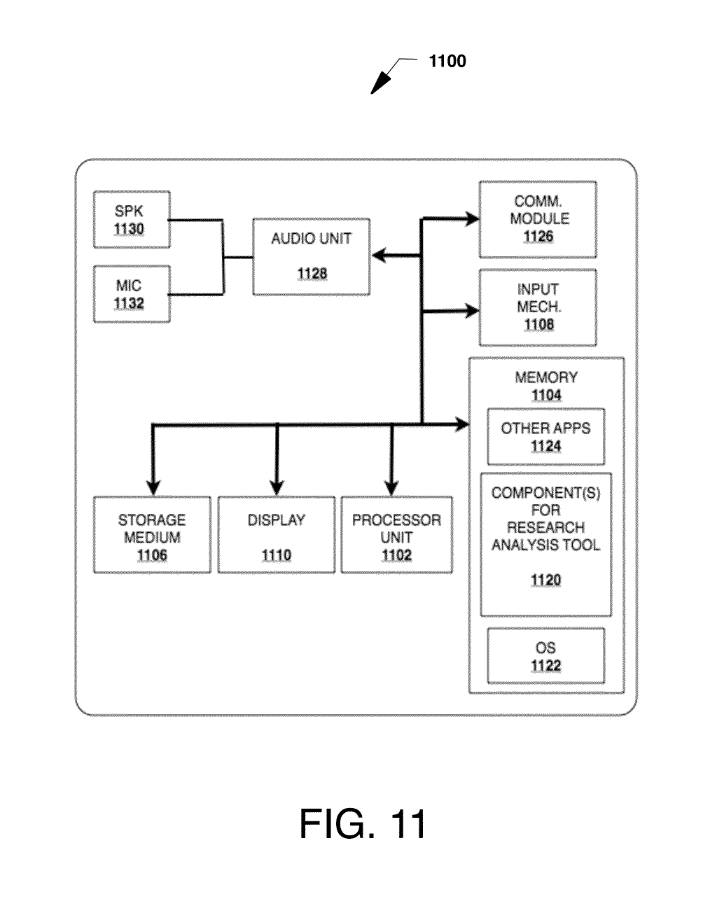

The data source server(s) 108, analysis engine 106, and computing device 102 may each be a single computing device, may all be the same computing device, may each be multiple computing devices operating in cooperation with each other, or other configurations known in the industry. An exemplary computing device is illustrated in FIG. 11 and is described below in conjunction with FIG. 11. Network 104 represents any type of network operating in its capacity to provide network connectivity to the data source server 108, analysis engine 106, and/or computing device 102 using well-known network standards.

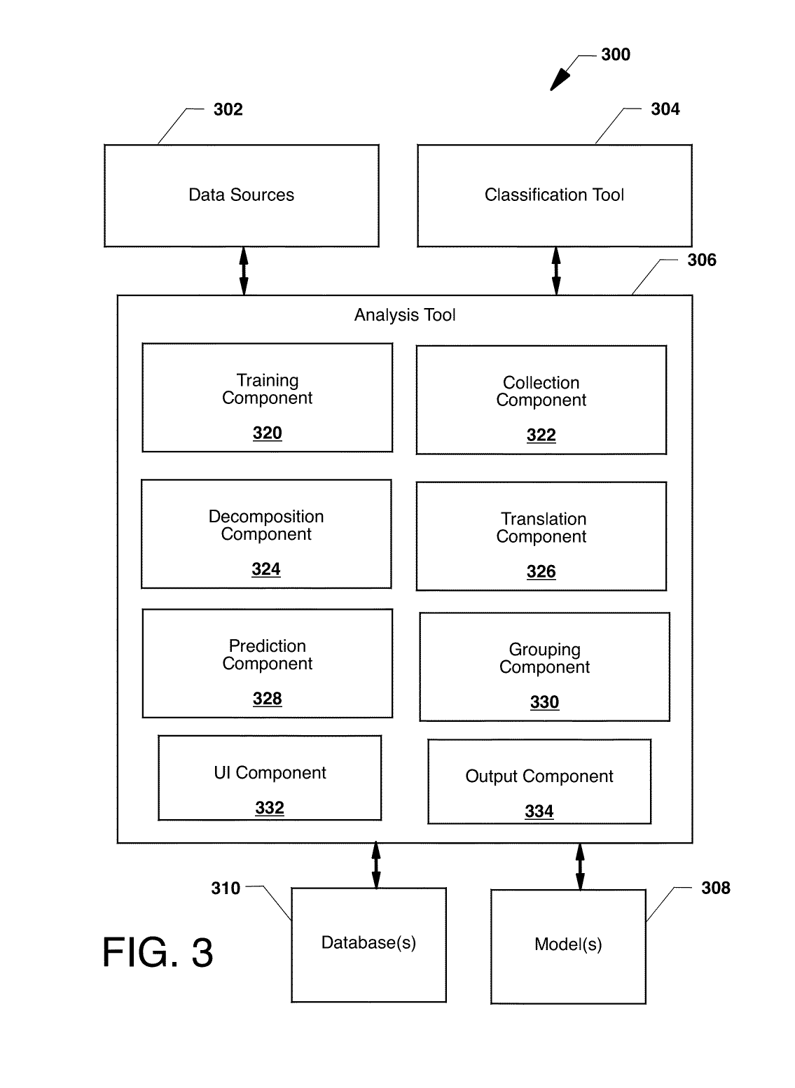

The database 110 may be an off-the-shelf database using any commonly available query language and/or search engine. The analysis engine 106 may populate database 110 with original data from the data source server(s) 108, information provided specifically for the performance of the analysis (e.g., training data, etc), information aggregated from the multiple data source servers 108, and information obtained after performing processing described below in conjunction with FIGS. 3 to 8.

In overview, analysis engine 106 collects data from the various data source servers 108, aggregates the data, performs analysis and predictions on the data based on a set of desired relationships and/or qualities, and generates related groupings of data that are stored in database 110. The related groupings may all be related by the same desired relationships and/or qualities, such as having related owners, or the groupings may be related by differing relationships and/or qualities, such as some having similar floor plans, etc. The plurality of desired relationships and/or qualities and the plurality of corresponding generated groupings may be independent, may be related or may be derived from one another. In addition, analysis engine 106 provides the related groupings of data to computing device 102 based upon the requested criteria. Because the data from the various data source servers 108 may have errors, omissions, and the like, the analysis engine 106 is configured to verify the data, determine relationships from the disparate data, and present reliable information to user 103 in an easily understandable format.

FIG. 2 is an exemplary graphical representation 200 of reliable information presented to a user on a display of a computing device based on data generated by the analysis engine, which is configured to analyze real estate data based on relationships pertaining to the real estate industry. In this embodiment, the analysis engine may provide the reliable information in a manner such that the reliable information is displayed as a related grouping 202 of parcels (shown as areas with diagonal stripes, including parcels 210-218). The related grouping 202 that is displayed depends on criteria requested by the user in a request to the analysis engine. In the past, real estate professionals typically located one parcel (e.g., parcel 218) based on criteria supplied by a client who was interested in parcel 218. The real estate professional may have obtained the owner of the parcel from the assessor's office that is responsible for identifying a taxpayer and a mailing address for the taxpayer for each parcel of land in order to collect taxes. However, because the taxpayer may be a person or an entity, the assessor office's data may not provide the level of detail needed by the real estate professional to obtain a person to contact. As will be described below, the analysis engine is configured to analyze the data and to predict whether the data represents a person or an entity and is then further configured to predict relationships based on the person or entity in a manner to accurately predict the owner of the property. Based on the predicted relationships, the analysis engine is configured to provide the real estate professional with enhanced information about the taxpayer, such as whether the taxpayer owns additional parcels. For example, the analysis engine may predict whether an entity with an ownership interest in the subject parcel also has, directly or via managerial or ownership interests in intermediate entities, an ownership interest in a nearby parcel. The more information that the analysis engine can predict and provide to the real estate professional about the owner of the requested parcel, the more likely the real estate professional will be able to assess the probability that they might or might not successfully transact business with the owner of the parcel, and the more likely they will actually be successful and fulfill the client's goals. Therefore, as will be described below, the analysis engine aggregates data from multiple data sources, analyzes the data, and predicts enhanced real estate information, such as additional parcels (e.g., parcels 210-216) that may not have the same requested criteria (e.g., same owner, same number of rental units, or the like). The aggregated information may be displayed graphically as a related grouping 202 (e.g., areas shown with diagonal stripes).

As mentioned above, the present system uses data aggregated from various data source servers to create groupings of relevant data. However, in order to create these related groupings of relevant data in an interactive and informative manner, the system had to overcome several challenges and problems. For example, one challenge was handling the vast amount of data from various data sources. Other challenges included handling various representations of data from the different data sources, misspellings, abbreviations, omissions, substitutions, and the like within the data. Additional challenges included devising a technique for predicting reliable enhanced data from the original data obtained from the data sources.

Before describing the present system any further, the following terms, which are used throughout the specification, are defined. A record refers to a particular item of interest related to an industry and is a unit of data input from a data source. For example, in the real estate industry, a record may be parcel taxpayer data from a county's assessor's office for a particular tax parcel or may be corporation data from a state's secretary of state's office. An element refers to a field within the record. Elements may be of different types (i.e., polymorphic). For example, a physical address may be one element. As will be described below, polymorphism allows the analysis system to treat elements generated by the analysis engine as if the generated element had been present in the original data sources 108 or vice versa. A sub-element refers to a further division of a field within the record. For example, one data source may treat the physical address as one variable length text field, while another data source may treat the physical address as four separate text fields for a street address, a city name, a state, and a zip code. A relationship represents a type of association between two or more items and is referenced with a unique name. For example, a relationship may be named PARCEL_PARCEL_SAME_OWNER, which represents an association between two parcels having the same owner. A quality represents an intrinsic characteristic determinable for one item and is referenced with a unique name. For example, a quality may be named SHOPPING_CENTER, which may represent a characteristic determined for one item (e.g, a parcel) as being part of a shopping center. As briefly mentioned above, polymorphism allows a quality that may be intrinsic to one data source element or an element generated by analysis engine 106 to be associated with another element. For example, an element identified as having the quality SHOPPING_CENTER may be associated with one parcel or it may be associated with an aggregation of parcels as generated by the analysis engine 106. A predictor is a process that makes a good guess as to whether a given set of items share a relationship or exhibit a quality. The predictor may include a trained classification tool, analytic algorithms, and/or the like. A feature represents a unique process or element and is assigned an arbitrary, but unique, identifier.

For example, when comparing two numbers, a feature may be named {DIFFERENCE} which is then associated with the unique process (e.g., absolute difference between two numbers). In another example, a feature may be named {CORP_IS_ACTIVE} which is then associated with the “ACTIVE” element from a secretary of state data source having corporation data. There may be several features that are provided as an ordered list of names and/or numbers. The name for each feature is preferably mapped to a unique integer on a relationship-by-relationship basis. In some embodiments, the integer mapping of a feature may be consistent across all uses of a relationship. However, the mapping does not need to be consistent between relationships. For example, the feature named {GOOD_PREDICTOR} may be mapped to the integer 7 every time for relationship CORP_OWNS_PARCEL and may be mapped to integer 13 every time for the relationship RELATED_CORPS. A datum is represented as one or more features, each with a corresponding value. In other words, a datum may be referred to as a mapping of feature to value. The feature indicates a process (e.g., comparison) that was performed or an element that was defined by a data source or defined polymorphically by the analysis engine. The value represents a result from the process, a data value retrieved from a data source, or a data value computed by the analysis engine.

The present system uses a technique to create a datum and then maps a feature in a datum to a dense range of cardinals in a manner so that a classification tool may be used to aid in predicting relationships and qualities. While the mapping to the range of cardinals is arbitrary, there are advantages to having the mappings remain consistent throughout the system. The datum may be represented as a vector with dimensions normalized to an interval [0,1.0] if the classification tool produces better results with normalization. A decoration refers to unique text, atomic value, or composite value (e.g., data structure) that is added to a record in the database to provide additional information to the classification tool for prediction purposes. Features may be directly derived from data of an original data provider or may be calculated or predicted. The feature's name (“feature name”) may be assigned to match the original data provider's name or may be different. New feature names may be created for new or existing values. The value for an existing feature may be replaced with a new value. Feature names are manipulated or created according to a consistent scheme which assigns the same name when the meaning of the value is the same. This consistency allows independent executions of a calculation to generate the same names for features calculated in the same context. For example, comparison of a feature named {CORP} to a feature named {TAXPAYER} may be assigned the feature name {CORP, TAXPAYER}. If the feature {CORP} is a composite structure with a member feature named {ZIP}, the full name of the CORP's ZIP feature may be {CORP,ZIP}.

FIG. 3 is a system view of components for implementing at least one embodiment of a research analysis system 300 in accordance with the present disclosure. While FIG. 3 and the corresponding description describes several components and interactions between the components, it can be appreciated that the system may include additional or fewer components or the functionality described for one component may be combined with another component without departing from the claimed invention. Thus, the described functionality of the components may be implemented using various permutations and combinations of components. The components may be implemented in software, firmware, and/or hardware, alone or in various combinations. In addition, while the description of FIG. 3 is described for an analysis system implemented for the real estate industry, those skilled in the art will appreciate that the analysis system may be implemented for other industries having disparate data sources and a need for analysis of and predictions from the data.

System 300 includes an analysis tool 306, one or more data sources 302, and one or more databases 310. The one or more data sources 302 may be from public sources (e.g., assessor's office, secretary of state's office, parcel boundary data), fee-based sources, data prepared specifically for the analysis system, and/or the like. The data sources may be external and/or internal entities that supply data and may include federal, state, county, city, and/or other data. The data may be imported using various well known techniques and may be in various data formats.

The system 300 includes a supervised learning classification tool 304 (hereinafter referred to as the classification tool 304). The classification tool 304 may be an off-the-shelf tool that is commonly available for providing supervised learning classification functionality. Typically, a classification tool is given input such as a set of measurements (e.g., length, width, color) that are used to classify a species. As will be described below, the inventors of the present research analysis system developed a technique for naming and describing results of the analysis of the original data in a manner such that the comparison and the results may be input into the classification tool. The naming technique and analysis method allow additional data sources having their own disparate data (e.g., another state's corporation data) to be added to the research analysis system typically without requiring additional training of the classification tool and/or modification to the research analysis method. The ability to add additional sources, relationships, and quantities, provides an extendable system for any number of industries. In addition, the inventors developed a technique for using the output of the classification tool to create one or more graphs which are used to form related groupings of data based on relationships of interest to the industry for which the analysis is performed. The relationships are customizable for each industry.

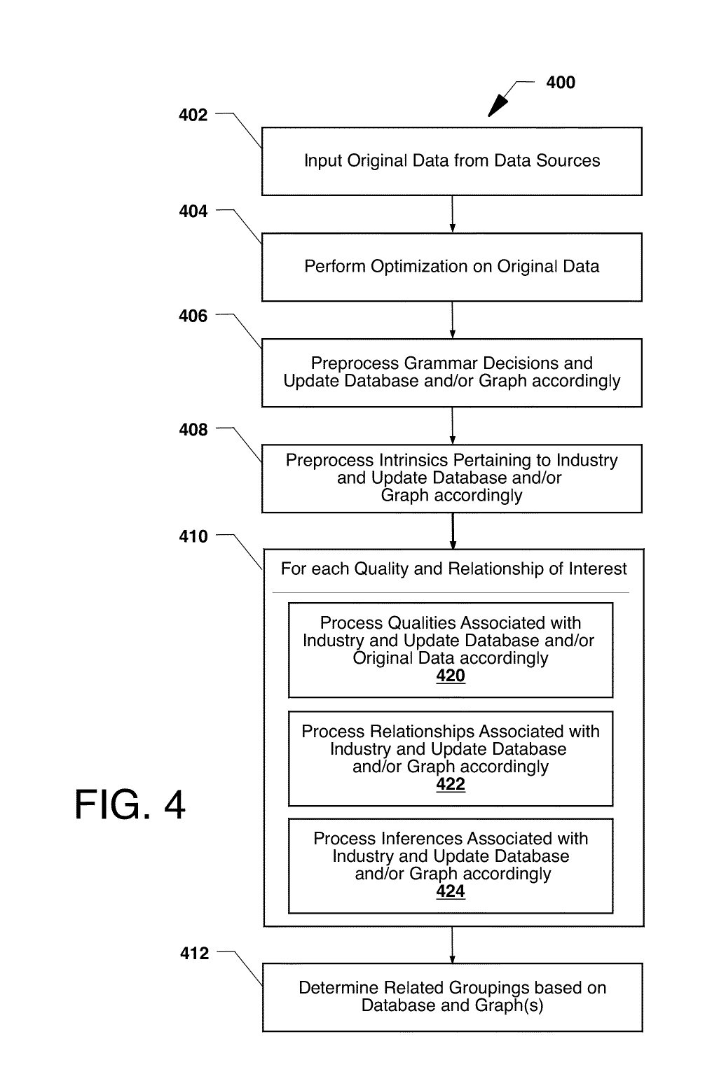

The classification tool 304 operates during a training phase and during a prediction phase. During the training phase, the classification tool 304 may be given a set of training examples that are identified as belonging to one of two or more categories. The classification tool 304 builds one or more models 308 that assign new examples into the one or more categories. The classification tool may use the models developed during the training phase to predict results during the prediction phase. During the prediction phase, the classification tool takes datum as input. For prediction of intrinsic qualities, the datum represents the data source attributes, computed entities, and the computed or predicted values of other intrinsic qualities of an item to be tested for the quality. For prediction of relationships, the datum represents the features used for intrinsic calculations for the items which may be party to the relationship and additionally the result of comparisons of the items. The creation of a datum is described below in conjunction with FIGS. 4-7. While the classification tool may internally use functional analysis, statistical methods, databases of classifications or any other method for determining its results, the present description describes the classification tool as an external classification tool that performs predictions. The classification tool manipulates a space populated by multidimensional points where the points are associated with the one or more datum that is input into the classification tool. The technique for creating a datum during analysis of the disparate data from the data sources allows the present research analysis system the ability to accurately and efficiently predict items for the industry of interest. As mentioned above, the creation of the datum is illustrated in FIGS. 4-7 and will be described in conjunction with each of those figures.

The analysis tool 306 may include a training component 320, a collection component 322, a decomposition component 324, a translation component 326, a prediction component 328, a grouping component 330, a user-interface (UI) component 332, and an output component 334. In overview, the analysis tool 306 obtains various sets of information from the data sources 302. Each set of information may have several records, where each record may include multiple elements, some with different types (i.e., polymorphic). In addition, elements of a given type may be composed of a varying numbers of sub-elements with each sub-element possibly being a variable length. The analysis tool 306 stores data in database 310. Database 310 may include the original data from the data sources, homogenized data based on the original data, predicted data, graph information generated from the predicted data, data prepared specifically for the analysis system, and/or data associated with the related grouping created during the analysis. Populating the database 310 may be performed off-line (in advance), online (on demand), and/or may be performed using a combination of the two. A discussion of each of the components shown in FIG. 3 for the analysis tool is now provided.

The training component 320 interacts with the classification tool 304 during a training phase. The training component 320 and classification tool 304 infer a function from labeled training examples and records the inferences in one or more of the models 308. The input structure of the datum to the classification tool 304 during the training phase is consistent with the input structure used during the prediction phase by the prediction component 328. The consistent input structure is described below in conjunction with the description of the prediction component 328 and the creation of a datum in FIGS. 4-7. During training, a datum is accompanied by an expert-defined correct classification to indicate whether the datum exhibits or does not exhibit the relationship or quality being trained. Training may be partitioned so that training for a quality or relationship is performed on all training examples for that quality or relationship, and is performed separately from all other qualities and relationships. The result of training for each relationship or quality may be a model which is recorded and named after the quality or relationship being trained. As will be discussed in further detail below, during prediction, the appropriate model is loaded into the classification tool to predict the requested quality or relationship from the data from the data sources. It is desirable to have the structure of the input datum in the training phase be consistent with the structure of the input datum in the prediction phase.

The collection component 322 interacts with the data sources 302 to collect data. As mentioned above, the data sources 302 may include county records, parcel boundary data, corporation data, specially prepared data, and the like. The collection component 322 may use well known techniques for importing the data from the data sources 302.

The decomposition component 324 may be configured to interact with the collection component 322 in order to homogenize the data by blending the unlike elements and sub-elements into a uniform composition that can be more easily processed by the other components. The decomposition component 324 may be further configured to decompose some of the elements into sub-elements in a manner to better facilitate the processing.

The translation component 326 is configured to produce a datum, which will ultimately be input into the classification tool. A datum is represented as one or more features, each being associated with a value. A name representing the feature may be mapped to a dense range of cardinals that are used by the classification tool. For the present description, translating a single item is referred to as an item mapping where the names for the features may represent an entity/quality/relationship of the item and the values quantify the value/quality/relationship. Translating a pair of items is referred to as item comparison where the names of each feature may indicate a comparison that was performed and the values represent the results of the comparison(s).

When the translation component 326 performs comparisons, the translation component generates a datum having one or more features representing the items compared and a resultant value or values for the comparisons. The datum includes a mapping of features to values. In some embodiments, the value may be a real number in an interval, such as [0.0,1.0], and/or a Boolean value, such as 0.0 (FALSE) or 1.0 (TRUE). Each feature may be mapped to a unique integer that corresponds to a dimension in the classification tool 304. Comparisons may be performed on “atomic” data structures representing a data structure from which other data structures are composed and/or on composite structures having multiple elements. Atomic data structures include primitives, such as a byte, an integer, a char, or the like. Comparisons may produce one or multiple feature mappings. In one embodiment, the translation component 326 compares each element from each record of one data source with each element from each record of another data source. Each refinement of the comparison produces a new dimension for the classification tool to analyze to determine a prediction. In some embodiments, if there are conflicting interpretations of the data from a data source, multiple interpretations for that data may be translated to produce new comparisons. In other embodiments, the translation component 326 may compare elements with a record of one data source with elements from each record of the other data sources based on a grid that specifies comparisons that would most likely yield valuable information to the classification tool.

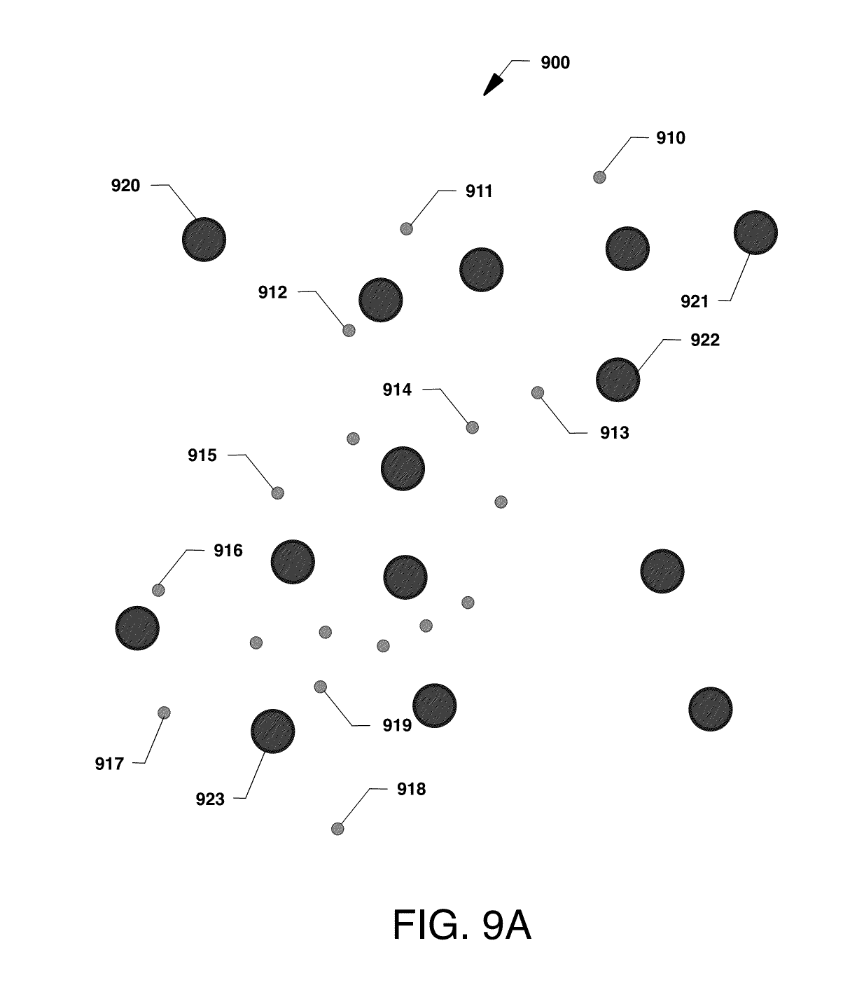

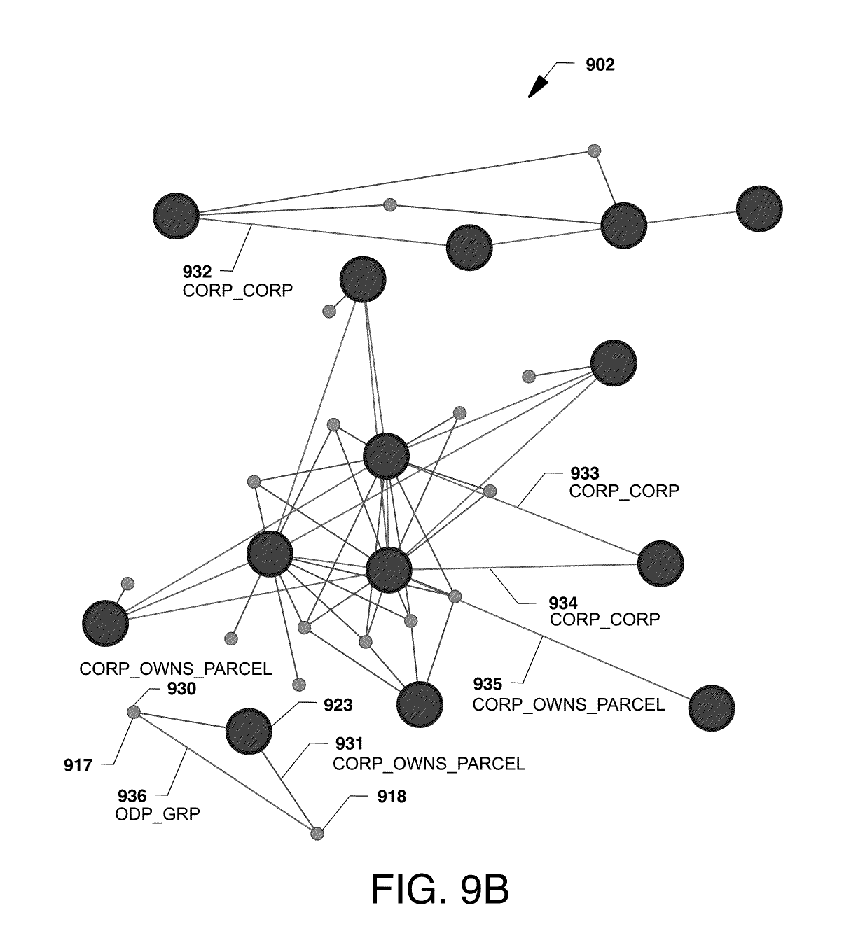

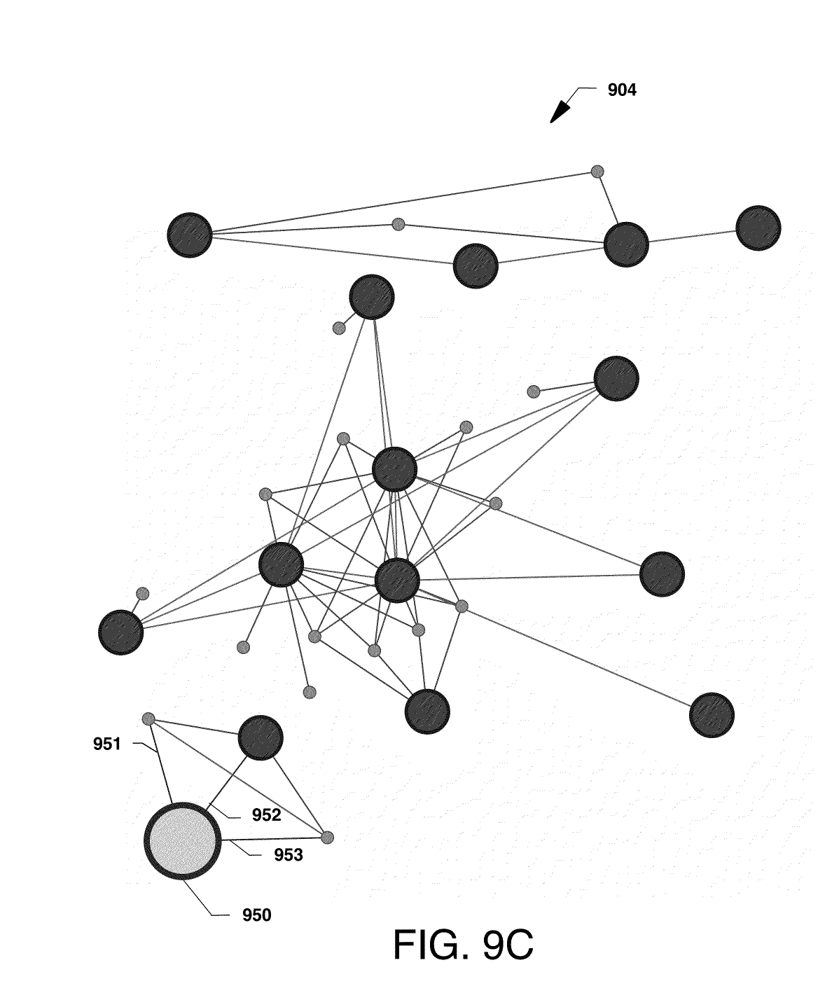

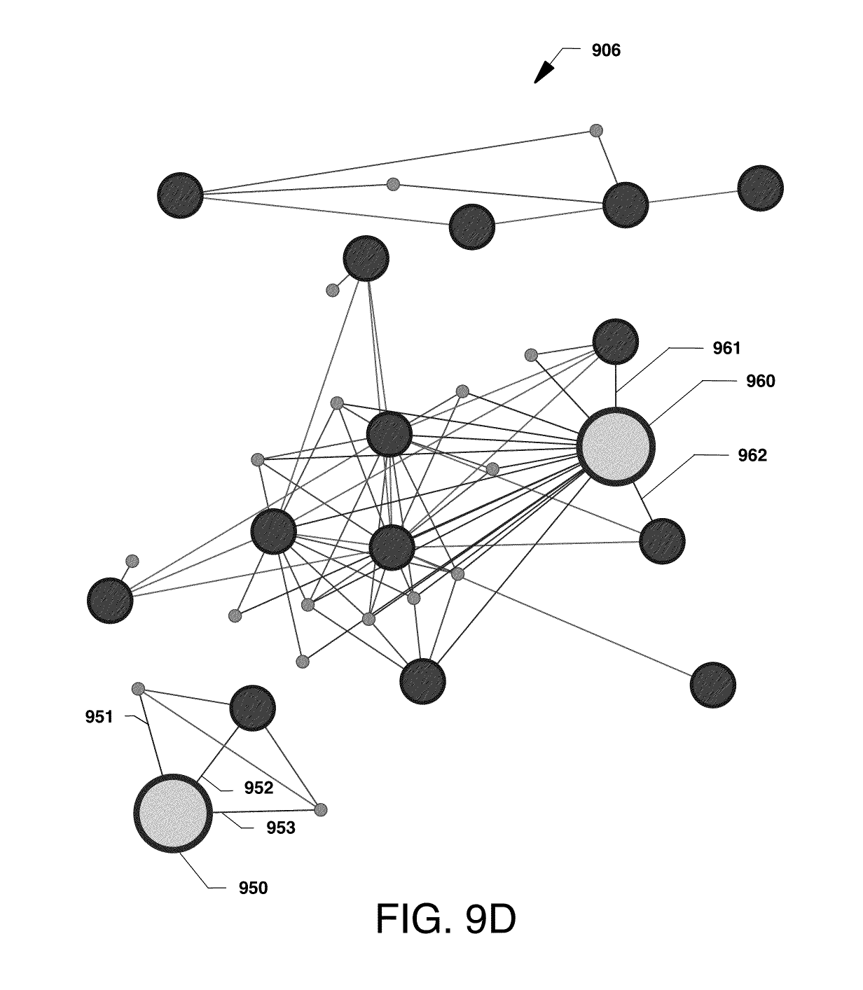

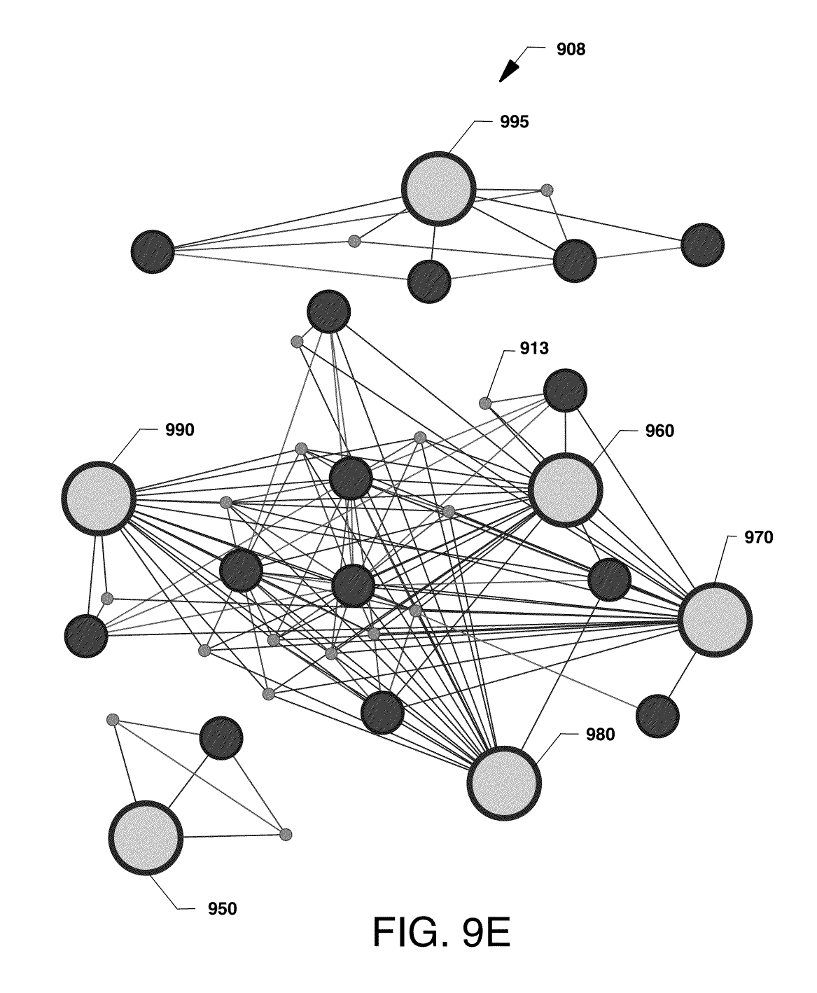

The prediction component 328 provides each datum generated by the translation component 326 as input to the classification tool 304 and receives prediction results from the classification tool for the inputted datum. In some embodiments, the classification tool 304 uses the corresponding model created during the training phase to classify the datum as to whether the datum exhibits, or does not exhibit, a relationship or intrinsic quality. In other embodiments, the classification tool may classify the datum into more than one group and/or may use a non-binary value. Based on the results from the classification tool, the prediction component 328 may build one or more graphs to represent the results of the predictions. In some embodiments, the graph has nodes that correspond to items (e.g., entities, person, parcels) and has edges connecting two or more nodes that correspond to a relationship between the connected nodes. FIGS. 9A-9B illustrate a series of exemplary graphs generated by the prediction component and will be described below in conjunction therewith. During training, in some embodiments, the prediction component 328 records comparison values without normalization. The interval observed in each feature in the resulting collection of training datum may then be used to normalize the value on a feature by feature basis based on output from the classification tool 304. During prediction, consistent normalization coefficients may be used and any normalized value falling outside the limits may be truncated. For example, if the normalized range is [0.0-1.0] and during prediction a value to be normalized is less than the minimum observed during training, the normalized value may be set to 0 and if the value to be normalized is greater than the maximum observed in training, the normalized value may be set to 1.0.

The grouping component 330 builds a related grouping based on the one or more graphs created by the prediction component 328. The related groupings may be saved in database 310 and may be associated with the relationship and/or quality that was predicted by the classification tool. FIGS. 4-8 illustrate an exemplary process for creating the related groupings, which will be described in conjunction with those figures.

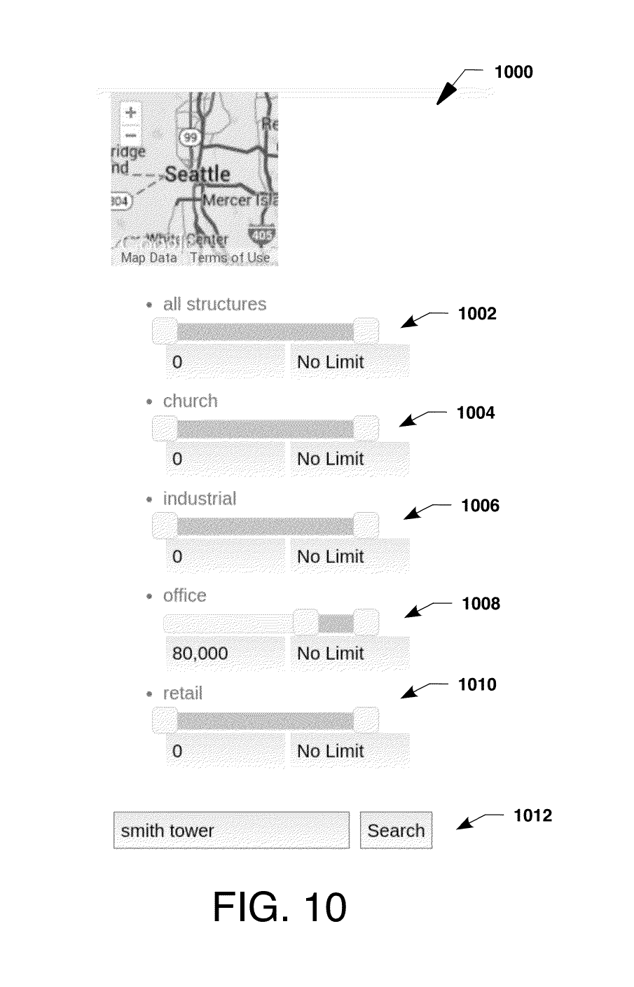

The user-interface component 332 handles the interaction between a user and the analysis tool 306. The user-interface component 332 may be a web-based interface, a mobile application downloaded to a user's mobile device, or the like. The user-interface component 332 allows a user to input criteria that determines which predicted results are requested. FIG. 10 is a display illustrating an exemplary user interface for requesting related groupings from the research analysis system and will be described in conjunction therewith.

The output component 334 obtains the related groupings and/or other items from the database(s) corresponding to the criteria specified by the user in the request and provides the related groupings and the like to the user. FIG. 2, described above, illustrates an exemplary graphical representation of a related grouping that may be provided by output component 334.

FIGS. 4-8 illustrate exemplary processes implemented by the one or more components illustrated in FIG. 3. The exemplary processes may be implemented by a computing device, such as the computing device illustrated in FIG. 11 and described below. The processes may be implemented using computer-executable instructions in software and/or firmware, but may also be implemented in other ways, such as with programmable logic, electronic circuitry, or the like. The processes described in FIGS. 4-8 are not to be interpreted as exclusive of other embodiments, but rather are provided as illustrative examples only.

FIG. 4 is a flow diagram illustrating an overview of an exemplary process 400 performed by one or more components illustrated in FIG. 3 during the prediction phase for determining related groupings. Prior to process 400, a training phase occurs to create models used by the classification tool during the prediction phase. Those skilled in the art will appreciate that the training data supplied during the training phase uses training data that simulates or is sampled from data that occurs during the prediction phase; training data may be a sample of the original data from data sources annotated with one or more classifications. Therefore, the present discussion does not describe the generation of the training data and/or the processing of the training data by the research analysis system to generate the models. Those skilled in the art, after reading the description for the prediction phase, will have sufficient knowledge to be able to train the classification tool without undue experimentation. In overview, during the training phase, the analysis engine trains the classification tool for the relationships and data that will be provided during the prediction phase. Training the classification tool and creation of the training data may be an iterative process whereby the nuances of the relationships may be learned in order to correctly predict the relationships.

In overview, the present research analysis system attempts to predict relationships that hold between two or more items (e.g., an item such as a parcel for the real estate industry). These predicted relationships are aggregated as described herein to produce enhanced real estate information. In addition, the research analysis system predicts intrinsic qualities for an item. The research analysis system employs a technique whereby each of the aggregated data source records having one or more elements is compared with another data source element and the comparison is uniquely identified in a manner such that the comparison may be input into the classification tool. Each uniquely identified comparison, computation and/or original element (hereinafter, collectively referred to as input to the classification tool) becomes a candidate dimension in the classification tool, where there are any number of dimensions. Training data for each input may be aggregated and provided to the classification tool when training the classification tool with respect to a quality and/or relationship. Thus, producing a model associated with a quality and/or relationship. Additional data sources may be added later to the research analysis system. If the same uniquely identified inputs are used, the research analysis system may not require re-training to handle the additional data source. In addition, the new data sources may define new inputs, which may be accompanied by new training data to produce a properly trained predictor.

In the embodiment illustrated in FIG. 4, process 400 creates a graph and creates/updates information about relationships between one or more items (e.g., parcels, corporations, etc. for the real estate industry). Thus, the graph may include nodes for each of the parcels and each of the corporations in the original data sources. While the owner of a parcel may be a person or an entity, such as a corporation, the owner may also be an unknown, if what is evident from the data is not enough to identify the owner of a parcel as being another node in the graph. This may occur, for example, if the owner cannot be identified as a known registered corporation. As will be described below, the research analysis system is configured to surmise that two parcels likely have the same owner, even though the owners are both unknown, or the research analysis system may be configured to surmise that two parcels have the same owner even though one owner is unknown and the other is not. Because the relationship “same owner” between two nodes cannot be decomposed into two “owner” edges connecting one owner with each owned node (or, by the same token, because the “same owner” relationship was not composed from two “owner” relationships joining the same owner node with two distinct owned nodes), the research analysis system analyzes the original data from the data sources and adds edges connecting one or more of the nodes if the nodes exhibit a relationship and labels the edge accordingly. After processing of blocks 402-410, several interconnected nodes are created where each connected node has some commonality with similarly connected nodes (i.e. all nodes connected by an edge labeled, for example, “SAME_OWNER” have a common type of relationship “SAME_OWNER” with one another; that is not to say that all nodes with an edge “SAME_OWNER” exhibit relationship “SAME_OWNER” with all other nodes having an edge “SAME_OWNER”). From these interconnected nodes, related groupings may be determined by forming sub-graphs of two or more of the interconnected nodes; the nodes in a grouping (sub-graph) may be connected by edges with the same labels or different labels and certain nodes connected by an edge may be excluded from the grouping (sub-graph). The following describes the processing performed by the research analysis system to generate these related groupings. As one can appreciate, any number of relationships may be analyzed. Likewise, any number of related groupings may be determined. The additional relationships and related groupings may be added by undergoing processing associated with the added relationship and then incorporating the added relationship when determining related groupings.

At block 402, original data from data sources is input. The original data from the various data sources each have multiple records, each record may have many elements of different types (i.e., polymorphic). In addition, elements of a given type may be composed of a different number of sub-elements. For example, one data source may store the physical address in one variable length text field, while another data source may store the physical address in four separate text fields: a street address, a city name, a state, and a zip code. The original data may be stored in the database as structured programming objects representing the underlying semantics of each record in the corresponding data source. For example, in the real estate industry, an exemplary object may have members such as tax parcel number, physical address, registered corporation, and the like. These objects may be augmented, after processing, with calculated intrinsic qualities (e.g., auto-correlations), calculated relationships, inferences, and the like.

At block 404, the original data may be optionally optimized in a manner that allows processing of the data to be more efficient. Optimizing the original data may include decorating the original data with supplemental data. This supplemental data may then be used during processing of blocks 406-410.

During blocks 406-410, the database may be decorated and one or more graphs may be created and updated. The decorations and updates occur in such a manner that subsequent processing in any of the blocks may access the updated information for use in its processing. The order in which blocks 406-410 are shown in FIG. 4 is merely for the convenience of explanation. In some embodiments, processing described for one or more of the blocks may be performed multiple times for a different quality and/or relationship or as a refinement to a previously processed quality and/or relationship. The processing in block 410 is performed for one or more relationships and/or qualities that are of interest and that are useful in determining the desired related groupings at block 412. The sequence for processing blocks 406-410 will be dependent on the relationships, qualities, and intrinsics for the particular industry and will be designed in a manner such that each block that produces decorations and updates is performed in an order for the decorations to be available for processing in subsequent blocks.

At block 406, grammar decisions are processed and the database and/or graph may be updated accordingly. Grammar decisions may include, but are not limited to, deletions, synonyms, abbreviations, inconsistencies in data from data sources, substitutions, and the like. Using heuristics, these grammar decisions may be used to automatically correct or homogenize the original data sources. For example, the text string “&” and “AND” are synonyms and one may be substituted for the other and stored in an updated database. Thus, the grammar transformations performed are treated as if the transformations are the original data as will be described below with an example in which synonyms and irrelevant re-arrangements of the original data generate additional datum input to the classification tool.

In overview, important key words, synonyms, and irrelevant re-arrangements for elements are processed by the research analysis system. However, it is difficult for the research analysis system to know for each instance how to interpret the elements. In one embodiment, multiple techniques are applied to the elements and the classification tool determines which information are good predictors and which information to ignore. In order to provide the information to the classification to make this determination, the present research analysis system employs a technique whereby potentially useful interpretations of ambiguous data are generated and then each of the interpretations are compared as if the interpretations are part of the original data.

In one technique for generating useful interpretations, after any ambiguous data has been identified, the ambiguous data is analyzed for lexical indicators of likely interpretations. The research analysis system then creates an enumeration called “Interpretation” for the useful interpretations. An algorithmic test is generated for each interpretation along with an algorithmic manipulator to create a canonical version of the interpretation, where the canonical version is the original data when the interpretation does not apply. The interpretation may be expressed as a test for appropriateness and a transformation into a canonical form. In one embodiment, a structure is created having a set for storing a name for and canonical value of each combination of the identified interpretations, such as that each element of the set corresponds to one combination of transformations. A name is created for each identified interpretation and possible sequences of application and non-application of the interpretation's transformation are calculated. Each such sequence is assigned a name which is unique to that sequence by combining the names of the applied transformations in the order in which they were applied, and the value is the result after applying each transformation in sequence to the result of the previous transformation (or the original data for the first transformation). The new data (the interpretations) which are treated as though they had been in the original data source is the whole set of uniquely named transformation sequences.

An example of applying these interpretations to generate additional data to compare is now presented. This example applies deletion and synonyms transformations to the strings, “JAMES, ROBERT AND PARTNERS LLC” and “JIM BOB PARTNER”. The goal is to have the classification tool determine in the larger context of a comparison what is significant and what should be ignored. In some embodiments, the research analysis system adds information to the original data so that the classification tool may use the additional information in its prediction. Because the research analysis system is designed not to prejudge the appropriateness of the transformations, the system treats each transformation independently. For example, if there are three transformations that may apply, the system applies each combination and keeps the various transformed inputs for comparison. The following represent different transformations that could be generated for “JIM BOB PARTNER”:

JIM BOB PARTNER (original)

JIM ROBERT PARTNER (synonym 1)

JAMES BOB PARTNER (synonym 2)

JAMES ROBERT PARTNER (synonym 1 and synonym 2).

The system is configured to name each of the transformations, such as ORIG, SYN_ROBERT, SYN_JAMES, and SYN_JAMES_ROBERT for the above example. The system is also configured to keep the assigned name for the transformations consistent, such that the fourth name is not SYN_JAMES_ROBERT sometimes and SYN_ROBERT_JAMES other times. This consistency may be achieved by ordering the transformations in the order the transformations are applied, naming the transformation alphabetically, and/or using other consistent naming conventions.

As will be described in more detail below, with the transformations generated and named as described above, the classification tool can then distinguish between the various string comparison features of the various versions. For example comparing a string FROM_ELSEWHERE and the string “JIM BOB PARTNER” above would yield values for at least these features:

{FROM_ELSEWHERE,ORIGINAL,STRING_SIMILARITY}
{FROM_ELSEWHERE,ORIGINAL,STRING_LENGTH}
{FROM_ELSEWHERE,SYN_ROBERT,STRING_SIMILARITY}
{FROM_ELSEWHERE,SYN_ROBERT,STRING_LENGTH}
{FROM_ELSEWHERE,SYN_JAMES,STRING_SIMILARITY}
{FROM_ELSEWHERE,SYN_JAMES,STRING_LENGTH}
{FROM_ELSEWHERE,SYN_JAMES_ROBERT,
STRING_SIMILARITY}
{FROM_ELSEWHERE,SYN_JAMES_ROBERT,
STRING_LENGTH}.

The number of combinations of n distinct transforms is 2ⁿ. Therefore, when processing grammar decisions, there are numerous transformations for a string. While each of the transformations may be computed, preferably, the system is configured to apply some heuristics to help reduce the actual number of combinations. The heuristics may be based on real-world premises about the intended semantics of the string. For example, several transformations may be defined to handle personal names and several may be defined for addresses; a heuristic may be used to not generate combinations of transformations where some presume a name and some an address, but rather to generate combinations of only name-transformations and then to produce combinations of only address-transformations. Similarly a heuristic may identify certain transformations as order-independent and therefore to only generate combinations which differ by more than the order of those transformations (replacing “BOB” with “ROBERT” and “JIM” with “JAMES” cannot produce different results by performing the replacements in different orders: these are order-independent transformations as will be described in more detail later).

The system may be configured to recognize when synonyms are for a person's first name, such as “JIM” and “JAMES”, “BOB” and “ROBERT”, “ANDY” and “ANDREW”, and others. The system may be configured to recognize that “LLC” or “THE” in a company name may be deleted. The system may also be configured to recognize that when forming synonyms for “ONE” and “1”, the system is handling cardinals and when forming synonyms for “FIRST” and “1ST”, the system is handling ordinals. The system may also be configured to recognize that when forming substitutions of “LLC” to “LIMITED LIABILITY CORPORATION” and of “LLP” to “LIMITED LIABILITY PARTNERSHIP”, the system is handling legal entity designations. Likewise, when the system forms a synonym “AVENUE” for “AVE”, the system recognizes the string is for a street address. These and other examples of transformations are handled by the system.

The system is configured to recognize with some confidence that a string is not a formal list of personal names and an address, even though the system is unable to recognize a priori what semantic the data source is using and the meaning of the string. Therefore, the transformation are grouped based on which have shared semantic implications. In some embodiments, the transformation groups are further divided so all members of a group G are mutually exclusive with all members of all other groups Gx and may be used in combination with every member of all other groups Gc where G, Gx and Gc form a partition of the universe of all implemented groups. In other words, all pairs of groups G1 and G2, either (A) every member of G1 can be used in combination with every member of G2 or (B) every member of G1 can be used in mutual exclusion of every member of G2. For example, imagine groups of transformation PersonalName and StreetAddress which represent mutually exclusive suppositions about the semantics of a string while the group OrdinalCardinal represents a supposition that might be applied in combination with the CompanyName or StreetAddress groups. Each group contains one or more transformation which may be used in concert with each other member of the same group: the CompanyName group includes transformations for deletion of LLC, for rooting synonyms “ASSOCIATES” and “ASSOC” and so on; the StreetAddress group deals with “AVE” and deletion of “UNIT” and so on. Note the following: (1) having made the StreetAddress interpretation mutually exclusive of the CompanyName interpretation, the system may be configured to add synonyms for “AVE” and “AVENUE” to the CompanyName group if the particular address-like synonym is common in non-significant company name alterations and (2) whether the interpretation is CompanyName or StreetAddress, the system allows combination with transformations from the CardinalOrdinal group.

The system may be configured to treat each group as a single (slightly more sophisticated) transformation and apply the transformations described above and name each string feature (each transformed version of the original string) after the combination of groups that produced it rather than the combination of particular synonyms or deletions that produced it. This has the advantages of reducing the number of dimensions the system presents to the classification tool, reducing the number of distinct string transformations the system must calculate and reducing the grouping semantics. Thereby, encouraging training from one example to transfer well to another. For example, when the system trains the classification tool with examples of one name being a short form for another: the transformation group gives a mechanism for arbitrarily presenting many different short forms in the same feature so that the system does not need to train the classification tool with examples of every known shortened name in every context where it may appear.

In a further refinement, the system may be configured to summarize key information that would otherwise be lost within a group's transformation. For example, consider the corporation types LLC and LLP. It seems to be typical that two corporate entities (in the same state, at least) may not have “overly similar” names, as defined by the Secretary of State for registering entities. It also appears that it is typical to modify the body of the name but not the type of the entity. For example, it is rare for “FIRST AVENUE INVESTMENTS LLC” to be entered as “FIRST AVENUE INVESTMENTS LLP,” but it might well show up as “1ST AVE INVS LLC”. Similarly, it is common to see “AND” and “THE” appear in only one of two strings without it harming the assessment of the quality of the match. For example, “THE PAPER MOON” may be a good match for “PAPER MOON” and “DEWEY CHEATHAM AND HOWE, LLP” may be a good match for “DEWEY CHEATHAM HOWE, LLP”. However, the story might be different for “THE HUGO HOUSE” and “HUGO AND HOUSE”. The problem is that once the system deletes the deletable token from the string, the identity of the missing element is lost. The generally problematic case is that a transformation produces a generally better-matching string but something significant is lost. The following improvement helps when the lost information is easily reduced to a boolean comparison. Because types of legal entities are enumerable, words that are allowably deleted may be enumerated.

In this improvement, a value may be cached with the string, where the value represents what was lost (e.g, the type of incorporation that was deleted, or the word of typically little semantic that was deleted—and a feature name for each class of loss). Note that “LLC” and “LIMITED LIABILITY CORPORATION” may both be represented by the same transformation-loss value (say, “LL”), while “CORP” and “CORPORATION” may both be represented by another transformation-loss value (say, “CO”). The “class of loss” is a grouping finer than the transformation group and containing semantically similar transformations which are mutually exclusive. “Class of loss” examples may include LEGAL_ENTITY or DELETE_THE, or DELETE_AND, and the like. Now, when the system transforms a string to produce a version named COMPANY_INTERPRETATION and deletes “LLC”, the system records with the string that the transformation-loss LL occurred. When the system later transforms another string to produce a version of that string named COMPANY_INTERPRETATION and deletes “CORPORATION”, the system records with the string that the transformation-loss CORP occurred. Later still when the system compares these two strings, the system compares all of the versions and when comparing the COMPANY_INTERPRETATION version, the system compares the values from all classes of loss and records boolean features (features with the value 1.0 when they are true and 0.0 when false) alongside the familiar { . . . , STRING_SIMILARITY} and { . . . , STRING_LENGTH} as follows:

1. Where there is no value for this class recorded with either transformed string, the system records no feature. When some comparisons record a feature and others do not, the unrecorded features are treated as though recorded with a value 0.0 (‘FALSE’). Normalization may discard features whose value never varies;
2. Where there are two values and they match, the system records the class and a match, for example { . . . , LEGAL_ENTITY,MATCH};
3. Where there are two values and they are mis-matched, the system records { . . . , LEGAL_ENTITY, MISMATCH}; and
4. Where only one version has a transformation-loss value, the system records { . . . , LEGAL_ENTITY,PRESENT_ONLY_ONE_SIDE}.

Note that the preamble to these features will include the context of the comparison, which includes the transformation in question (e.g., { . . . , COMPANY_INTERPRETATION, LEGAL_ENTITY, MATCH}.

The ultimate effect is to lose positional information (which could be restored with appropriate additional recording) and erase irrelevant detail like whether LLC was spelled out here and abbreviated there, while maintaining and calling out the key facts:

1. Only one string specified a legal entity type; or
2. Both specified a legal entity type and they were the same type; or
3. Both specified a legal entity type and they were different; or
4. Neither specified a legal entity type.

At block 408, intrinsics pertaining to the industry may be processed. For example, in the real estate industry, intrinsics may include determining a gross square feet of a building, an age of a building, a standardized encoding of the use or construction of a building and/or the like. As will be described below, each intrinsic that is processed is assigned a unique feature identifier (a unique name). In the real estate industry, another example of an intrinsic may include a weighted frequency of registration for each registered agent of a corporation which aids in determining the likelihood that the agent field will be helpful in determining the relationships between a corporation and other corporations or parcels or the like.

For example, the weighed frequency of registration for each registered agent may be assigned a unique feature identifier such as COMMON_REGISTRANT_WEIGHT. In one embodiment, the weighted frequency of registration for each registered agent may be determined by sorting and grouping the original data from a corporation data source based on an agent's name and address. The agent addresses may be sorted and grouped to determine the most common agent names and addresses, which may signal that the agent is a hired agent and not an owner. The grouped and counted agent names and addresses and counts may be stored for later use in an “Observed Registrant Frequency” database or the like. Knowing that the agent is likely a hired agent is useful information for the classification tool when basing its prediction of parcel ownership on all the datum available. Thus, a datum for this intrinsic property may include the feature name COMMON_REGISTRANT_WEIGHT and a value that indicates the likelihood that the agent represents an owner for the parcel. In one embodiment, a higher value represents the less likely the listed agent is the owner for the parcel. The value may be determined by comparing records from other data sources with the agents identified in the common agent list, “Observed Registrant Frequency”. Any matching algorithm may be used to compare subject agents with the entries in Observed Registrant Frequency. One embodiment uses the following comparison algorithm: if the string compare is an exact match, a value of 1 may be assigned, and if the string compare is a 50% match, a value of 0.5 may be assigned, and if the string compare is less than a 50% match, a value of 0.0 may be assigned. The weight so determined for an agent name and address in Observed Registrant Frequency is multiplied by the count of occurrences in Observed Registrant Frequency to yield a weighted count. All of the weighted count values for all entries in Observed Registrant Frequency may then be added together to determine a weight that represents the likelihood that the element does not represent an ownership interest in a corporation or an owner of a parcel or the like. The feature identifier along with the cumulative weight may then be included in the database and included with any datum that is generated for the element. Thus, the weighted value represents the likelihood that the associated element will provide useful information when determining a relationship or an intrinsic (e.g., owner in this example) associated with the element.

At block 410, each quality and/or relationship of interest in determining a related group is processed. Block 410 includes blocks 420-424. Thus, processing in blocks 420-424 may be performed multiple times for different relationships and/or qualities. The outcome from processing in each block may be used for processing in a later block and or subsequent processing within the same block. Once the necessary relationships and qualities have been processed, processing proceeds to block 412 to determine a related grouping. Before describing block 412, the processing performed in blocks 420-424 is described.

While the processing of qualities and relationships are similar, there are subtle differences. For example, qualities may be determined for one item in isolation while relationships pertain only in the context of two or more items. Thus, qualities may be recorded inside an item (as a ‘decoration’) while relationships are recorded as edges in a graph that is being built by the research analysis system. Typically, qualities may be easier to calculate than relationships. Taking this into account, the research analysis system may be configured to advantageously calculate qualities before processing relationships.

There are many example of qualities and relationships that may be processed in block 410. For example, for the real estate industry, block 410 may handle processing for parcels that have the same owner, parcels involved in a non-arm's length property transfer, parcels that were once owned by a current or former owner of interest, parcels associated with a former business, parcels associated with a former address, owner/person related to a business determined by licensing information, corporations owning parcels similar to criteria for parcels, corporations selling parcels similar to criteria for parcels, corporations purchasing parcels similar to criteria for parcels, corporations facing financial changes, corporations facing management changes, and the like. The research analysis system is envisioned to handle numerous types of qualities and relationships associated with a specific industry and to handle many different specific industries, where the real estate industry is one example of an industry.

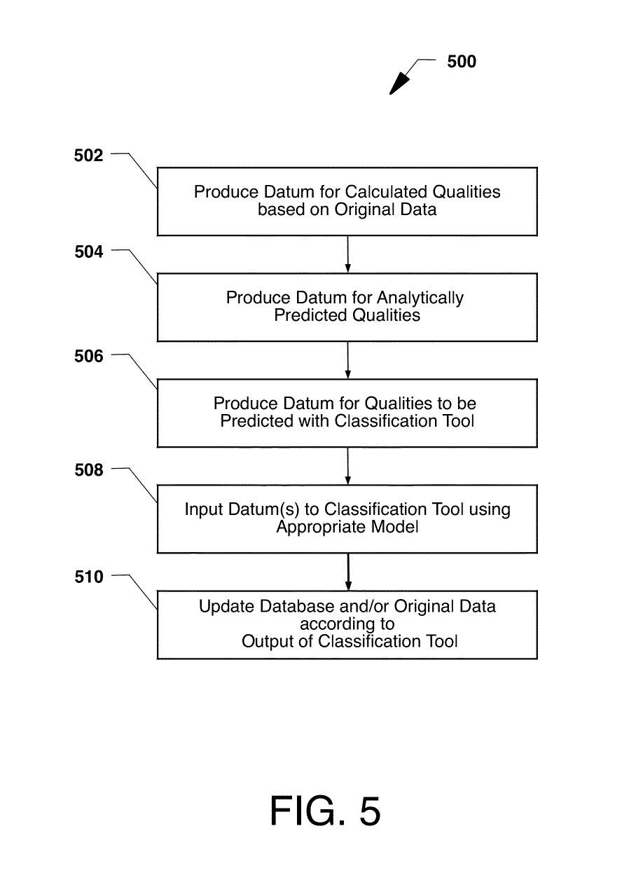

At block 420, qualities associated with the industry are processed. The qualities may be intrinsic qualities that can be determined for one item alone. The intrinsic qualities may be determined analytically and/or may be predicted using the classification tool. FIG. 5, which will be described later in more detail, illustrates a flow diagram for an exemplary process for processing qualities associated with an industry and updating databases and original data accordingly.

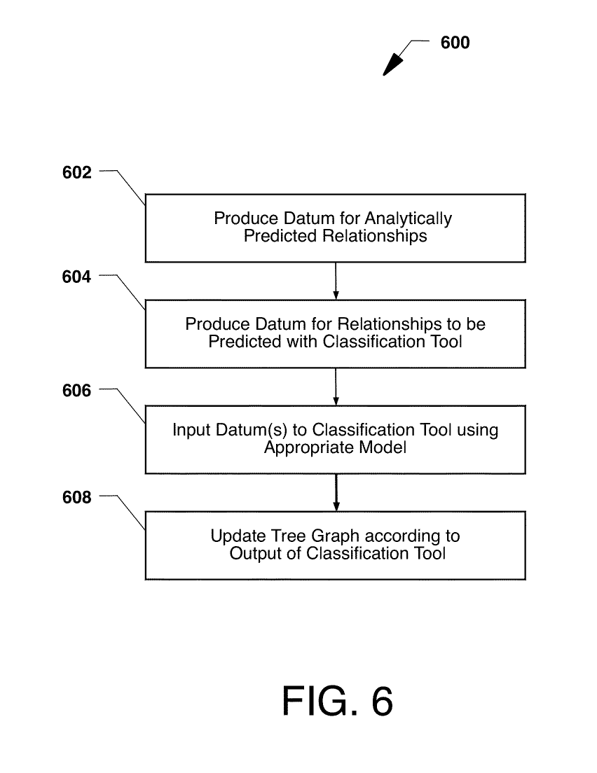

At block 422, relationships associated with the industry are processed. Relationships are typically dependent on the type of industry for which the research analysis tool is being implemented. FIG. 6, which will be described later in more detial, illustrates a flow diagram for an exemplary process for processing relationships associated with an industry and updating a database and/or graph accordingly.

At block 424, inferences associated with the industry are processed and the database and/or the graph is updated accordingly. The processing of inferences may arise while processing qualities and/or relationships. An inference occurs when the graph does not use the associated object as a node or the item can not be uniquely identified or its value as provided by the original data provider is somehow incomplete. However, because information regarding the inference may be useful when predicting some other relationship, the inferences may b3 recorded by decorating each associated record with a full expression of the inference. In another embodiment, a new node in the graph may be created along with the existing nodes and the inference may be directly recorded as a relationship using the newly created node.

In addition to relationships, inferences may be recorded by annotation of the nodes in the graph or the original structures to which they refer. For example, in the real estate industry, an inference such as POTENTIAL ALTERNATE MAILING ADDRESSES may be made when the same taxpayer seems to appears in different records with different addresses. In one embodiment, nodes are not created for each hypothetical taxpayer but rather the information about each hypothetical taxpayer is recorded where it is found: in a parcel record. Thus when it is inferred that two or more parcels refer to taxpayers have POTENTIAL ALTERNATE MAILING ADDRESSES, the research analysis system may join their nodes with an edge indicating a relationship POTENTIAL_ALTERNATE_MAILING_ADDRESSES or may instead record the finding by decorating all of the parcel records with a description of the inference. In one embodiment, the description may be an encapsulation of the inference as it pertains to the inferred items. For example, new feature(s) may contain copies of all the potential alternate addresses. In other words, tax parcels may be decorated with the inferred information that its taxpayer's address is related to the addresses of the identified parcels. One benefit of this embodiment is that address information which is provided with different inaccuracies in different places for the decorated parcels may be used when the research analysis system encounters typographical errors and omissions between the various addresses during its analysis of data. The decision to record an inference as a relationship, as a decoration, or as both hinges on how much information is represented by the inference, what other processing may depend on or benefit from the finding, and what other processing depends upon the inference. In one embodiment, the potential alternate address inference may be made early on and may be used in heuristics which reduce the processing required to calculate other relationships and features before the graph is created. In this embodiment, it is advantageous to record the inference by decorating the affected subject records.

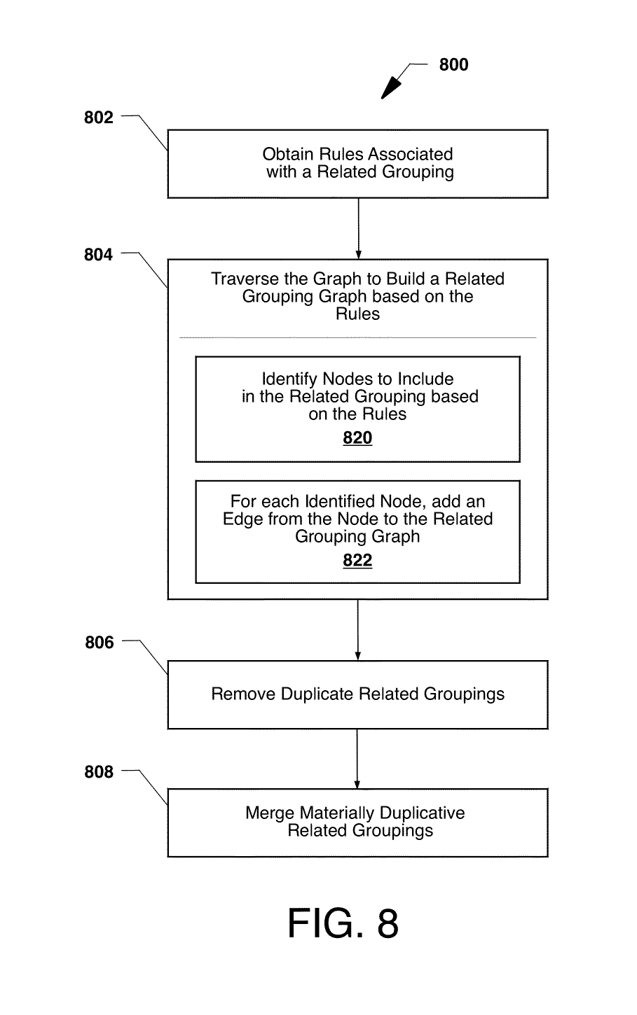

After the qualities, relationships, and inferences have been processed in block 410, processing proceeds to block 412. At block 412, related groupings are determined based on the graph(s) that have been created and updated. Thus, in the real estate industry, block 412 may analyze the graphs for the relationships where a corporation owns a parcel (CORP_OWNS_PARCEL), for the relationship where two or more parcels have the same owner (PARCEL_PARCEL_SAME_OWNER), or for the relationship where two or more corporations are related (RELATED_CORPS), for example by sharing member entities. Using these graphs, the relationships may be ‘walked’ to identify sub-graphs satisfying certain criteria. Each sub-graph may be tagged or recorded or merged into a related grouping. The related groupings may then be further processed to identify sub-groupings having other criteria, such as parcels that share ownership and are geo-spatially proximal based on a proximity criteria (e.g., with common boundaries, within 100′ of one another, within same county, within a list of counties, within a state, etc). While some embodiments may be implemented using graphs, other embodiments may be implemented using relational database techniques for maintaining the relationship, quality, and inference information. FIG. 8, described later in more detail, illustrates a flow diagram for an exemplary process for determining related groupings based on the database and/or graph.

FIG. 5 is a flow diagram illustrating an exemplary process 500 suitable for use in block 420 of FIG. 4 for processing qualities associated with an industry and updating the database and/or original data accordingly. The order in which blocks 502-510 are shown in FIG. 5 is merely for the convenience of explanation. In some embodiments, processing described for one or more of the blocks may be performed multiple times for a different quality as a refinement to a previously processed quality. The sequence for processing blocks 502-510 will be dependent on the qualities associated with the particular industry and will be processed in a manner whereby blocks that produces decorations are performed in an order such that the decorations are available for any processing in subsequent blocks.

At block 502, a datum is produced for calculated qualities based on the original data. Calculated qualities include values that may appear in different formats in the original data of the various data sources. The disparate values are calculated in a manner to provide a consistent semantic having a universal name. For example, the gross square feet may appear as a sum of several fields in the original data of some data sources, but may appear in a separate fields in the original data of other data sources. Thus, a value for any calculated quality is determined and will be consistently used in calculations. Examples of calculated intrinsic qualities include the square feet, an age of a building, and the like. These calculated intrinsic qualities are included in the database and can be later searched upon to perform further analysis. Each of the qualities are given a universal name and a universal semantic.

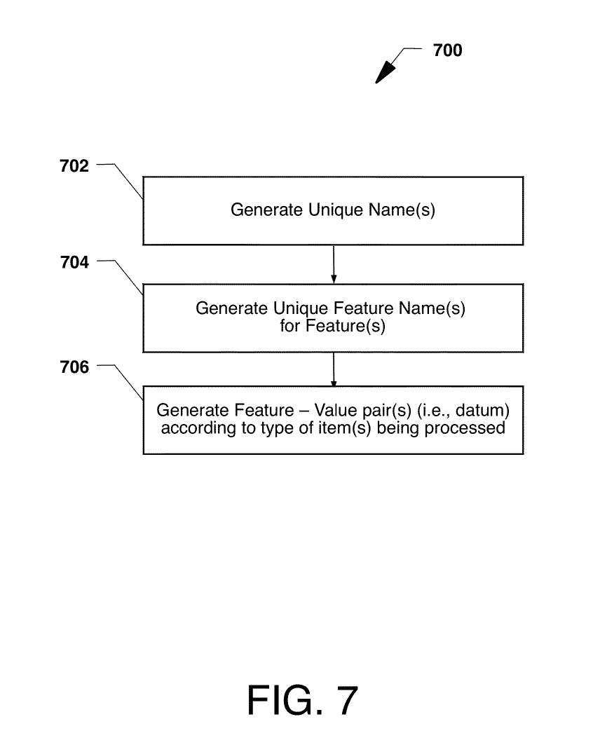

At block 504, a datum is produced for analytically predicted qualities. For example, qualities which may reflect two or more possible values may be analytically predicted based on the original data. These qualities may be analytically predicted by determining whether a field contains an enumeration or ranged value. The production of the datum for analytically predicted qualities is described in further detail in conjunction with FIG. 7 which illustrates the creation of a datum for different types of data. In one embodiment, the datum for analytic qualities is produced in the same fashion as the datum for qualities predicted by a classification tool. In another embodiment certain analytic qualities are calculated directly from the data as provided by the original data sources. More than one method may be used in different situations for the same quality and more than one method may be used for different qualities.

At block 506, a datum is produced for qualities to be predicted by the classification tool. The datum may then be input to the classification tool to predict the quality. The datum may be obtained using a technique hereinafter referred to as item mapping. The datum represents attributes of the item being tested for the quality. The process for creating a datum based on an item mapping is illustrated in FIG. 7 and described in conjunction therewith.

At block 508, the datum(s) are input into the classification tool that has the appropriate model loaded. As previously mentioned, during training, each relationship is trained using training data to create a corresponding model. Thus, at block 508, the model corresponding to the relationship being processed has been loaded.

At block 510, output from the classification tool is obtained. In one embodiment the output represents a Boolean value indicating whether the datum that was input belongs to the category or not. The output from the classification tool is used to update the item that was tested for the quality. The update may be made to the original item or it may be stored in a database or the like.

FIG. 6 is a flow diagram illustrating a process 600 suitable for use in block 422 in FIG. 4 for processing relationships associated with an industry and updating the database and/or graph accordingly. The order in which blocks 602-610 are shown in FIG. 6 is merely for the convenience of explanation. In some embodiments, processing described for one or more of the blocks may be performed multiple times for a different relationship as a refinement to a previously processed relationship. The sequence for processing blocks 602-610 will be dependent on the relationships associated with the particular industry and will be processed in a manner whereby blocks that produce decorations and updates to the graph are performed in an order such that the decorations and updates are available for processing in subsequent blocks. Apart from the difference regarding the number of items involved when processing and how the findings are recorded, the processing for qualities and relationships proceed in much the same fashion.

At block 602, a datum is produced for analytically predicted relationships. Datum for testing for analytically predicted relationships may be produced by comparing appropriate fields in the original data associated with the relationship. For example, some data sources may identify parcels as a “group account” if the data source's author believes that there is one common taxpayer for the group of parcels. This “group account” indicator is a useful predictor of common ownership. Therefore, presence of the relationship PARCEL_PARCEL_SAME_OWNER can be determined by comparing a table from the data source that lists group accounts and comparing two or more records. The relationship analyzing group account may be given a unique name distinct from other causes of the suspicion of same-ownership, such as PARCEL_PARCEL_DEFINITELY_SAME_OWNER. Processing performed to determine related groupings (e.g., block 412 in FIG. 4) may analyze the final graph to determine which edges (relationships) may be superfluous or erroneous (the ones without which the analysis would yield more meaningful and reliable results). Thus, such an analysis may take into account the similarities and differences between the meanings of “PARCEL_PARCEL_SAME_OWNER” (determined by a fairly reliable predictor) and “PARCEL_PARCEL_DEFINITELY_SAME_OWNER” (determined by an extremely reliable original data source) while determining which edges to trim and which to keep. In this example of an analytically predicted relationship, the analysis tool then identifies all parcels with the same value for GROUP_ACCOUNT and creates edges labeled “PARCEL_PARCEL_SAME_OWNER” connecting each with every other node having the same GROUP_ACCOUNT value. If the analytically predicted qualities relate items which are represented as nodes in the graph, the analytically predicted qualities may be recorded in the graph in the same manner as other relationships using edges tagged with the relationship's name.

At block 604, a datum is produced for relationships between two or more items to be predicted with the classification tool. The datum represents the attributes, along with the previously processed qualities of the items, as well as the results of a comparison of items. The comparison may compare two or more items. The corresponding datum for predicted relationships includes one or more item mappings and an item comparison. Item mappings include any available intrinsic qualities, inferences, auto-correlations, and/or calculated qualities. A process for creating item mappings is illustrated in FIG. 7 and described in conjunction therewith.

At block 606, the datum(s) are input into the classification tool that has the appropriate model loaded. As previously mentioned, during training, each relationship is trained using training data to create a corresponding model.

At block 608, output from the classification tool is obtained. In this embodiment the output represents a boolean value indicating whether the datum that was input belongs to the category or not. The output from the classification tool is used to build a graph that depicts predicted relationships and/or qualities. An edge is added between the subject items (nodes) if the datum belongs to the category and a name is added to define the relationship associated with the edge. Thus, objects (nodes, e.g., such as entities for the real estate industry: parcels, corporations and the like) and their relationships (edges, e.g. CORP_CORP_SAME_OWNER) are represented by the graph. A database containing information about the nodes and edges may be maintained and made available during and after processing. Thus, the information in the graph may be used in analyzing subsequent relationships. For example, the original data may first be processed to predict entities that are owned by a corporation (e.g., CORP_OWNS_PARCEL) and parcels having the same owner (e.g., PARCEL_PARCEL_SAME_OWNER) and corporations having common ownership (e.g., RELATED_CORP). Using the information from these three predictions, groups of parcels with related owners may be predicted.

FIG. 7 illustrates an exemplary process 700 for creating a datum for different types of data. Process 700 is performed for both item mapping and item comparisons. Depending on the type of data involved for the item mapping and item comparison, process 700 will generate the datum accordingly. The following discussion describes some exemplary generations of datum given different data types. These examples are for illustrative purposes. Those skilled in the art will appreciate that process 700 may be implemented with other data types without undue experimentation.

At block 702, a unique name is generated for the field(s) being processed. In one embodiment, the unique name may be structured as follows: DATA_SOURCE_NAME, TABLE_NAME, COLUMN_NAME, which correspond to the name of the data source, a name for the table obtained from the data source, and a name for the column within the table, respectively. For example, if the original data that is being processed was from a county's parcel records in the county of Capitol and the field being processed was the planning zone field, the unique name for the field may be:

CAPITOL_COUNTY, PARCEL_RECORDS, PLANNING_ZONE.

At block 704, a unique feature name is generated for the feature being processed. The feature may be associated with a quality, a relationship, an inference, or the like. Continuing with the example above, in one embodiment the planning zone field may have the following possible options: industrial, retail, residential, or farmland, which corresponds to an enumeration type in the present research analysis system. For enumerations, each option may then be used as a unique feature name for the item, such as INDUSTRIAL, RETAIL, RESIDENTIAL, FARMLAND.

At block 706, a feature-value pair is generated according to the type of item(s) being processed. A datum is a list of one or more feature-value pairs. The type of items include enumerated values, ranged values, comparisons, and the like. Continuing with the example above in which the type of item is associated with an enumerated value, the feature-value pair includes determining a value for each of the features (e.g., INDUSTRIAL, RETAIL, RESIDENTIAL, FARMLAND). Because a single parcel is listed as being only one of the enumerated types, a value of TRUE or FALSE is listed for each feature with only one of the features having the value of TRUE. The following illustrates an exemplary datum for the example enumeration:

{CAPITOL_COUNTY, PARCEL_RECORDS, PLANNING_ZONE,
INDUSTRIAL}=FALSE
{CAPITOL_COUNTY, PARCEL_RECORDS, PLANNING_ZONE,
RETAIL}=FALSE
{CAPITOL_COUNTY, PARCEL_RECORDS, PLANNING_ZONE,
RESIDENTIAL}=TRUE
{CAPITOL_COUNTY, PARCEL_RECORDS, PLANNING_ZONE,
FARMLAND}=FALSE.

Process 700 is performed for each feature-value pair. If this datum was generated for an item mapping, the process would supply the datum to the classification tool. If, however, the datum was generated for an item comparison, process 700 may be performed for other feature-value pairs before supplying the datum union of this datum and other feature-value pairs to the classification tool. Each of the unique feature names are mapped to a unique number that is input to the classification tool. As mentioned above, mapping of a feature may be consistent across all uses of a relationship, but does not necessarily need to be consistent between relationships since the research analysis system builds the graphs for the separate relationships independently.

The following discussion provides example feature-value pair(s) (i.e., datum) for different item types along with an explanation regarding the feature-value pairs generated by process 700. If the item type is a ranged value, a normalized value for the field may be determined. For example, if there is a range of 0 to 40 acres for the field associated with acres, a single twenty acre parcel in Capitol county may be given a value of 0.5. The feature-value pair may then be represented as follows:

{CAPITOL_COUNTY,PARCEL_RECORDS,PARCEL_ACRES}=0.5.

While the above-described examples illustrate the generation of a datum for calculated qualities, a similar process is performed to create the datum for an intrinsic quality and/or a simple calculated intrinsic. For example, a unique name is generated for the intrinsic, a unique feature name or several unique names is/are generated, and one or more feature-value pair(s) is/are processed.

In addition to generating a datum for calculated qualities, intrinsic qualities, and/or simple calculated intrinsics, process 700 may also be used to determine a datum for an item comparison. As mentioned above, an item comparison yields one or more features indicating the similarity, difference or other comparative measure of the two items being compared and a value produced by the comparison. A datum is produced from these feature-value mappings. For comparisons, in some embodiments, the comparison is symmetrical such that compare (a, b)=compare (b,a). For example, the comparison of two numbers (a,b) may not be the arithmetic difference a−b because a−b may not always be equal to b−a but it may be the modulus (absolute value) of the difference, |a−b|. An exemplary comparison for an atomic data structure is described below where an atomic data structure is one of a small number of simple data structures from which composite structures are composed. Comparison of composite structures may then be defined in terms of comparing each of the atomic elements from which they are composed in a recursive and/or iterative manner. For any item that is composed of other items, process 700 may be recursively or iteratively processed with each datum being prepended with a unique name associated with that item and the context of the iteration or recursion.

Item qualities or intrinsics may be processed as intra-record comparisons which compare one or more elements from the same record and/or may be processed as inter-record comparisons which compare one or more elements from a record from one or more different data sources, or with aggregate functions of those sources. An example of an intrinsic on an aggregate function of the same data source may include parcel records that may have an intrinsic calculated and appended to them that relates their size in acres to the entire population of parcels from the same data source. An example of an intrinsic on the same record includes parcels that may have a number of features added representing the result of comparison of the parcel situs (property address) and the same parcel's taxpayer address. Other examples include the agent registrant frequency already described above. Item record comparison may compare each element of each record for all the records in each data source. A datum is generated for each of the comparisons which will correlate to a number of dimensions for the classification tool to manage. In addition, in some embodiments, when there are conflicting interpretations of the original data, multiple interpretations of the original data may be compared with each interpretation to produce multiple datums, which are input to the classification tool. As a refinement, a grid indicating which elements in one data source are compared with which elements in another data source may be used to reduce the datum generated.

During the comparison process, if a comparison of a first element with the second element is not implemented, an equivalent comparison of the second element with the first element may be used if the comparisons may be symmetrical. In some embodiments, the values associated with a feature may be normalized in a manner, such that if the value falls outside of the normalized limits, the value is truncated (e.g., value<0 truncated to value=0 and value>1 is truncated to value=1).

Atomic comparisons include comparisons of two numbers, comparisons of two simple strings and comparisons of a string and a number. While there may be variations to these atomic comparisons, one skilled in the art after reading the present description will be able to generate a datum without undue experimentation. The following describes the generation of a datum when comparing these data types. While the description describes comparing two items having various data types, one skilled in the art will appreciate that additional items may be included in the comparison and follow the processing outlined in FIG. 7.

When the feature includes a comparison of two numbers, process 700 generates unique names for the fields associated with the numbers and a unique name for the feature. The following represents a generic representation of the feature-value pairs generated for comparing two numbers (e.g., NumComp (n0, n1)):

{{DIFFERENCE}=abs(n0−n1)},

where the comparison yields a value that is determined to be the absolute difference between the two numbers and the unique feature name is DIFFERENCE.

In general, the research analysis system may add any number of comparison results, so long as the results are named uniquely. This may be thought of as a comparison function returning a data structure containing a multidimensional or composite value. For example, in one embodiment, the research analysis system may also calculate the difference between two numbers as a ratio (as well as the linear difference) using arithmetic, such as RATIO=abs((n0−n1)/(n0+n1)). The exemplary comparison function above, NumComp (n0, n1)), would now yield the two-dimensional datum:

{{DIFFERENCE}=abs(n0−n1), {RATIO}=abs((n0−n1)/(n0+n1))}.

As described in more detail elsewhere, the general approach is to generate unique names by compounding non-unique names. DIFFERENCE may always be named DIFFERENCE but the difference of A and B may be named, for example, {A, B, DIFFERENCE} and the difference of C and D may be named {C, D, DIFFERENCE}. By following some simple rules about compounding, those skilled in the art will quickly see how to develop a naming scheme that generates consistent and unique names for atomic elements and compound elements, whether they are from the original data, computed from the original data, calculated by the processes described herein, or the like.

In certain situations, if the comparison context is asymmetric, the comparison may yield two features: DIFFERENCE and SIGNED_DIFFERENCE, where the feature-value pair generated for the feature DIFFERENCE is as explained above and the feature-value pair generated for the feature SIGNED_DIFFERENCE may be represented as {{SIGNED_DIFFERENCE}=n0−n1}.

When the feature includes a comparison of two simple strings, process 700 generates unique names for the fields associated with the two simple strings and unique names for two features: STRING-SIMILARITY and STRING_LENGTH. Thus, the comparison yields two feature-value pairs, one feature-value pair associated with the similarity of the strings (e.g., STRING_SIMILARITY) and one feature-value pair associated with the sum of the number of characters in each string (e.g., STRING_LENGTH). The value for the string similarity measure may use a Jaro-Winkler distance (JWD) which may by normalized in a manner such that 0 indicates no similarity and 1 represents an exact match. The following represents one embodiment for a generic representation of the feature-value pairs generated for comparing two strings (e.g., Compare (s0, s1)):

{{STRING_SIMILARITY}=StringSimilarity(s0, s1),
{STRING_LENGTH}=(Length(s0)+Length(s1))},

where s0 and s1 represent the two strings. This is another example of a comparison yielding a compound value as seen with DIFFERENCE and RATIO above. Again, in another embodiment, the research analysis system may compound many elements into a comparison result. For example, for a numeric ratio, the research analysis system may add a string length ratio as follows:

```
    Compare (s0, s1) = {{STRING_SIMILARITY}=
            StringSimilarity(s0, s1), {STRING_LENGTH}=
            (Length(s0)+Length(s1)),
{STRING_LENGTH_RATIO}=((Length(s0)+Length(s1))/
abs((Length(s0)−Length(s1))))}.
```

When the feature includes a comparison of a string and a number, process 700 attempts to perform two comparisons. The first comparison attempts to convert the number to a string and then compare the two fields as two strings. The second comparison attempts to convert the string to a number and compare the two fields as two numbers. Each of the comparisons include a datum indicating whether or not the conversion was possible, such as either CAN_CONVERT=TRUE or CAN_CONVERT=FALSE. The datum is the union of these two comparisons along with the CAN_CONVERT feature indicating whether the conversion for the respective comparison was possible or not. The following represents a generic representation of the feature-value pair generated for comparing a string and a number (Compare (string, number)):

Prefix(STRING_AS_NUMBER,
Union(

Compare( string, numConvertedToString(number)),
CanConvertNum(string) ? Union({CAN_CONVERT} = TRUE,
Compare( number, stringConvertedToNum(string))) :
{CAN_CONVERT}=FALSE)).

The first compare proceeds as described above for comparing two strings, whereas the second compare proceeds as described above for comparing two numbers.

Although not commonly considered primitives due to their frequent presentation as strings, dates are very common in data and generally have fairly reliable formatting. While dates may be treated using the general treatment described for ambiguous grammars, in some embodiments, the research analysis system may treat some or all dates as primitives.

For example, when the feature includes a comparison of one date/date-time with another date/date-time, process 700 proceeds as described above for comparing two numbers after both of the dates or date-times have been converted to a number representing the elapsed time since some reference date-time. The conversion that is applied may be arbitrary but remains consistent for the two conversions.

When the feature includes a comparison of one date/date-time with a string, process 700 proceeds to perform a test to determine whether a conversion from the string to a date is possible and then a comparison is performed as described above for two strings. The feature CAN_CONVERT feature indicates whether the conversion was possible or not. The following represents a generic representation of the feature-value pair generated for a comparison of one date/date-time with a string (CCompare(string,date)):

Prefix(STRING_AS_DATE, CanConvertDate(date) ?
Union({CAN_CONVERT}=TRUE, Compare(string,SScanDate(date))) :
{CAN_CONVERT}=FALSE).

When there are multiple possible but mutually exclusive formats for conversion, each of the possible formats may be processed using a distinct test, conversion, and prefix identifier. Thus, for formats F1 to FN, tests ConConvertFormat1 to N, conversions SScanFormat1 to N, and Prefix identifiers STRING_AS_FORMAT1 to N. This is a special case of the ambiguous grammar/multiple interpretations method described herein. The general case is that the many “formats” (interpretations) may be applied in any combination and in any order and that the order may be significant. This optimization is for the special case that it can be determined that only one of the “formats” (interpretations) could reasonably be present for any given instance of an item and that combinations are not appropriate. For example, the interpretation of a string as a date in the format “MM/DD/YY” cannot reasonably be supposed at the same time as supposing that the date is in the format “DD/MM/YY”. In this special case, the optimization is to allow only one interpretation at a time. The general situation, described elsewhere, is that the interpretations are not mutually exclusive (e.g. it could reasonably be supposed in a single instance of an item that the interpretation “AVE” in a string means the same as “AVENUE” could be appropriate at the same time as the interpretation “NE” in a string means the same as “NORTHEAST”).

The research analysis system is configured to assign a consistent feature name to each of the various member-elements of a composite structure when performing comparisons with a non-atomic (composite) data structure. “Consistent” means having a fixed relationship between the name of the element and its semantics. There is a finite number of feature names and each feature name takes a single value. Techniques employed by the research analysis system include naming the feature after the field name from the original data source, naming the feature after the name used for the member in the programming language of choice or naming the feature by other static means. In certain situations, the naming is more complex, such as in situations where the data structure is not of finite size (e.g., sets, lists and the like) or where the structure contains multiple, unnamed and interchangeable elements (e.g., sets, unordered lists and the like). These more complex cases may be dealt with as described below. Composite data structures may be paralleled by composite feature names. Where a composite structure's member-element's feature name is “A”, the sub-features of A may all be prefixed with “A”. For example, if a composite structure has a numeric member “Acres,” the feature name may be “ACRES” and its (normalized) value might be 0.5:{ACRES}=0.5. If the same composite structure also has a numeric member “AssessedValue,” its feature name may be “ASSESSED_VALUE” and its (normalized) value might be 0.3:

{ASSESSED_VALUE}=0.3.

The simplest comparison with a non-atomic element is a comparison of one atomic element with one non-atomic structure. Consider comparison (e.g., CompareVector) of an atomic element A with a structure B whose members are named m1, m2, . . . , mn. The result of CompareVector(A,B) is the union of Prefix(m1, Compare(A, m1)), Prefix(Compare(A,m2)), . . . , Prefix(Compare(A,mn)). For example, comparing a numeric value 0.5 with the composite structure in the example above would generate the result:

{{ACRES,DIFFERENCE}=0.0, {ASSESSED_VALUE,DIFFERENCE}=0.2}.

Notice the atomic comparison feature “DIFFERENCE” is prefixed with the feature names of the composed elements, “ACRES” and “ASSESSED_VALUE”. This is described in detail below.

Composite comparisons compare non-atomic data structures or atomic data with non-atomic data. Composite comparisons use the union of the datum produced by cross-product of element comparisons. The following represents a generic representation for a composite comparison (Compare (A,B)):

Union(CompareCross(A,B)).

The CompareCross(A, B) of a data structure A with a data structure B may include comparing every member of A with every member of B. Each of the comparisons include a feature identifier unique to those two compared members of the two structures A and B; the names may be generated by prefixing names generated as already described in CompareVector. Where the data members of A are named a1, a2, . . . an and the data members of B are named b1, b2, . . . bn, a generic representation illustrating the cross product for two non-atomic data structures is as follows:

CompareCross(A,B) -> Union(
Prefix(a1, CompareVector (a1, B)), ...,
Prefix(a2, CompareVector(a2, B)), ... ,
Prefix(bn, CompareVector(an, B))).

If A and B are of the same type, the cross product will generate two equal-valued, same-named comparisons for every member. In one embodiment, either one of the comparisons must be omitted when creating the datum union.

When the feature includes a comparison of an ordered collection (ordered in semantically significant way, such as seniority or total area, not for example, an arbitrarily assigned account number) of a known maximum size, process 700 generates the datum as the union of a sorted list of datum with each element prefixed by an identifier. For example, to compare an ordered collection OS of elements S with any atomic or compound structure T, where the collection of elements of OS has a known maximum size ks and an actual size cs (cs<=ks), a vector product of the members of OS with T is formed with all pairs (s,T) for all s in OS. The cs pairs of elements are compared in order and the results is the union of the sorted list of datum with each element n=[1 . . . cs] prefixed by a feature name n. In other words, the ordered collection is treated as though it had been a structure SS with members named after the position of and assigned the values of the members of the ordered collection OS, and the structure compared with T as in CompareVector(SS, T).

When the feature includes a comparison of an ordered collection (ordered in semantically significant way, as above) of an arbitrary size, process 700 generates a datum as the union of a sorted list of datum with each element prefixed by a unique identifier and the arbitrary list is truncated at K elements. The value of K may be determined by any means, including experiment or analysis to determine the value that yields the best balance of execution time and prediction accuracy. Once the list is truncated at K elements, the datum is determined as described above for comparison for ordered collections of a known maximum size, where K is the maximum size.

When the feature includes a comparison of an unordered collection (or a collection ordered in a semantically meaningless way, as excluded above) of a known maximum size, the unordered collection is first ordered in some meaningful way. Once ordered, process 700 generates a datum as described above for an ordered list of a known maximum size. Different techniques for ordering may be used.

When the feature includes a comparison of an unordered collection (or a collection ordered in a semantically meaningless way, as excluded above) of an unknown length, the unordered collection must first be ordered in some meaningful way. Once ordered, process 700 generates a datum as described above for an ordered list of a known maximum size.

The ordering of unordered collections may be performed in isolation, with only the collection to be sorted as input, or it may be performed using a method which is dependent on the context of the comparison. For example, the ordering of an unordered collection may vary depending on the item being compared. In some embodiments, the research analysis system may perform the ordering of two unordered collections in concert, before feature generation, with the order of the elements in each collection depending not only on the values of the other elements of the same list but also on the values of the elements of the other list. The order may further depend on the overarching cause(s) for the comparison which may include the quality or relationship being tested.

In another embodiment, one method for ordering an unordered collection is to compare all the members of the collection (before any truncation) with the other comparison element and to use a heuristic on the results of the comparison as a sort criterion on the original collection. One such heuristic may assign higher values to comparison results that are deemed more likely to improve the accuracy of the prediction by the classification tool. Those more predictive members of the collection are sorted to the top of the newly ordered list (and preferentially retained where the collection is to be truncated). If desired, the collection may then be truncated in its sorted form. For example, when comparing lists of an arbitrary length, the feature-value pairs that are useful in predicting whether there is commonality between members of a corporation are not all the mismatches (the poor matches), but rather the good matches. Advance determination of the “good” matches allows the research analysis system to sort by “goodness” and provide the classification tool with the top K results. Generally speaking, the “Goodness” is not necessarily the closeness of the match (as in this example) but rather the usefulness of the match as a predictor. The determination of the “Goodness” factor may depend on the relationship being processed. For example, when identifying related companies, closeness of the match may be an indicator likely to be useful to the classification tool. However, when identifying companies in an upheaval where upheaval may be indicated by membership changes, the goodness factor may be determined by governing members with the least best match. In one embodiment, a best match may be found for each member and then the members may be sorted in reverse order. As described for the weighted agency calculation above, any feature may be weighted so that the feature may be sorted accordingly. In general, one exemplary implementation for determining the goodness factor may examine every comparison involved in a list of comparisons and then assign a weight to every feature produced by the comparisons. A positive weight may reflect when a result of a compare returns a higher value corresponding to a “better” match. Conversely, a negative weight may reflect when a result of a compare returns a higher value corresponding to a “worse” match. A weight of “0” may represent that the value of the compare does not directly relate to the quality of the match. The goodness is then the sum of all the weights. The list of datums may then be sorted by goodness with the highest values first.

Comparison optimization may also be performed to decrease the number of datum input to the classification tool. Which comparisons may be omitted with acceptable change in predictive accuracy may be determined experimentally, analytically, and/or using heuristic. For example, a predetermined comparison grid may be created for comparing records from one data source with records in another data source. Some of the comparisons may be removed if the removal of the comparison has little or no detrimental effect on accuracy. For example, certain pairs of structure members may not be compared based on data type or broad semantic differences, such as not comparing a date of incorporation of a corporation record with a mailing address zip code of a tax parcel record. In addition, lexical interpretations of some structure members may be omitted if the interpretations would be unproductive. For example, interpreting a mailing address city as a parcel joint owner may be omitted. One technique for reducing the variety of comparisons and the number of features and the number of labeled training examples required for a given level of accuracy is to map fields from the different data sources to a small set of data members in one homogenized database. For example, a column for a taxpayer's city that appears in several different tax parcel data tables may be mapped to a same member in a single homogenized data structure rather than using several distinct members of the same data structure or several different structures. In another example, many distinct values of many different fields from many different providers may be mapped to a smaller number of values with a smaller number of labels. This is a special case of calculated features. For example, a collection of fields from one original data provider may signify a broad semantic like the use of a parcel. Each original data provider (data source server) may use a different set of fields and a different set of values indicating different semantic details. However, in some embodiments, the research analysis system may map large numbers of these fields, values and fine semantics (perhaps CONVENIENCE_STORE, DRIVE_THROUGH_RESTAURANT, PET_STORE etc.) to a single feature with small number values, each with broad semantics (perhaps just RETAIL). The original features and values may be retained (which may increase accuracy at the cost of computation and training) or may be removed (which may cause the opposite effect).

Another technique for reducing the number of features is to discard some features after their generation. In some embodiments, the research analysis system may be designed to attempt to discard the least predictive, such as by sorting features in descending order of predictability and discarding the tail. Sorting heuristics may be implemented in any block, for example within process 700 when generating the feature-value pairs. The sorting heuristics may be employed to limit the number of feature-value pairs that are input to the classification tool by selecting the feature-value pairs that would be the most useful to the classification tool when predicting the relationship.

When all of the datum generated with respect to one record as been completed, the union of the datum for that record is input into the classification tool (e.g., block 508 in FIG. 5, block 606 in FIG. 6) to predict the result. The result then predicts the qualities and relationships that may be added to a graph. Examples of graphs generated during the process described in FIGS. 3-7 are illustrated in a series of figures including FIGS. 9A-9B. This series of figures will now be described before describing how the related groupings are determined from these graphs, which will be described in conjunction with FIG. 8.

FIG. 9A illustrates an exemplary graph 900 which illustrates several nodes (e.g., nodes 910-923). In overview, during process 400 (blocks 402-410) for our exemplary real estate example, a graph is generated with nodes representing all corporations and all parcels. An edge is added for every relationship and is tagged with the corresponding relationship type: the graph contains an edge connecting each pair of parcels with the same owner, each pair of corporations with common membership and each corporation-parcel pair where the corporation owns the parcel. A “related grouping” sub-graph is then formed by reviewing the graph to identify sub-graphs connected by these edges (e.g., RELATED_CORPS and CORP_OWNS_PARCEL) as will be described in process 800 of FIG. 8. Prediction of relationships may be imperfect so apparently inconsistent graphs may be generated where, for example, two parcel nodes are joined by an edge “SAME_OWNER” but only one (not both) of the parcels is joined to an owner by “CORP_OWNS_PARCEL” edges as the semantics imply. The capacity of the graph to represent this incomplete picture is a strength rather than a weakness. The ultimate conclusion that one parcel's owner owns both parcels is computed in block 412.

Referring back to FIG. 9A, for simplicity, graph 900 does not illustrate any edges. The nodes are determined based on the original data provided from the data sources based on the industry for which the research analysis is implemented. In the present exemplary embodiment for the real estate industry, nodes may represent parcels which may be represented by an address, an entity name, a general description, or the like. For example, in FIG. 9A, nodes 910-919 (e.g, smaller circles) represent properties and nodes 920-923 (e.g., larger circles) represent corporations. In order to minimize the complexity, not all of the nodes representing properties and/or corporations are labeled with reference numerals in the following FIGURES. FIG. 9B illustrates an exemplary graph 902 which illustrates the same nodes shown in FIG. 9A (most node reference numerals have been removed for readability), along with edges (e.g., edges 930-936) that occur between two nodes. Each edge has an associated label that represents the association between the two nodes. For example, several edges (e.g., edge 936) may be associated with a label “ODP-GROUP”, representing that in the original data, the data source provider listed the nodes as a group (e.g., all in one shopping center, etc). One will note that not all edges having the same label are in the same group. Rather, it indicates that the two nodes (e.g, nodes 917 and 918) connected between the edge have been identified as being in an ODP group. The intricacies of determining how this affects the determination of related groupings is described in conjunction with process 800 illustrated in FIG. 8. Thus, each edge is labeled and that label will be used in determining the related groupings. For example, edge 935 is shown associated with a label “CORP_OWNS_PARCEL”, representing that the two connected nodes are associated because one node representing a corporation owns the parcel represented by the other node. In FIG. 9B, other labels include “CORP-CORP.” For convenience, FIG. 9B is a simplified graph that shows at most only one edge with one associated label between any two nodes. However, it is common to have multiple edges with different labels between the same two nodes. This may result in one node occurring in different related groupings after processing performed in FIG. 8. In addition, FIG. 9B illustrates where each of the nodes are joined to at least one node. However, this not not necessarily the general situation, as some nodes in the graph may have no edges at all connecting them to any other node.

FIG. 8 is a flow diagram illustrating an exemplary process for determining related groupings suitable for use in the process illustrated in FIG. 4. Once the graphs and database(s) have been updated, such as the graphs shown in FIGS. 9A-9B have been created, the related groupings are identified using process 800. The related groupings represent some semantic that is exposed by the relationships after analyzing the nodes and edges of one or more of the graphs. The related groupings may be augmented or altered in later processing. In overview, the research analysis system traverses the graphs and collect nodes into meaningful groups (e.g., related groupings). In some embodiments, the graph may be undirected. For these embodiments, any two nodes may be connected to each other by edges, and is connected to no additional nodes in the graph. Those skilled in the art will be familiar with the graph theory definition of a connected component of an undirected graph. In other embodiments, the graph from which the related groupings are constructed may be directed. Processing performed in process 800 is now described.

At block 802, rules associated with a related grouping are obtained. The research analysis system may be configured to have several rules that are derived from the semantics of the analyzed relationships. There are rules that constrain process 800. For example, certain relationships are commutative (they are undirected: if A→B, then B→A) while others are not (they are directed: A→B does not imply B→A). Other relationships are transitive (if A→B and B→C then A→C) while others are not (A→B and B→C does not imply A→C). A commutative relationship can be seen as a bidirectional edge (or, equivalently, as a pair of directed edges between the same vertices but pointing in opposite directions). The RELATED_CORP relationship is commutative: if Corporation A is related to Corporation B then Corporation B is related Corporation A. The CORP_OWNS_PARCEL relationship is not commutative: Corporation A owns Parcel B does not imply Parcel B owns Corporation A. Thus, the rules that are obtained depend on the related groupings that are being built.

At block 804, the graph built during process 400 is traversed to build the related grouping based on the rules. One will note that while traversing the graph one or more related groupings may be built using the rules. For example, one related grouping may be all parcels owned by Corporation A and another independent grouping may be all parcels owned by Corporation B. Thus, because the rules for both of these related groupings are the same, process 800 may build two separate related groupings. Briefly turning to FIGS. 9C and 9D, one will note that FIG. 9C illustrates one related grouping (e.g., related grouping node 950) built from the exemplary graph illustrated in FIG. 9B, whereas FIG. 9D illustrates two related groupings (e.g., related grouping nodes 950 and 962) built from the exemplary graph illustrated in FIG. 9B. Once the graph is traversed to build the one or more related grouping nodes, process 800 proceeds to block 806. However, before discussing block 806, the processing that occurs while traversing the graph to build the one or more related groupings is described in conjunction with block 820 and 822.

At block 820, nodes are identified to be included in the related grouping based on the rules. During processing in block 820, the graph built during process 400 (hereinafter referred to as graph 400) is used. When the number of nodes is small, a satisfactory method for calculating all groupings may be achieved as follows:
1. Calculate a set CANDIDATE GROUPINGS of all sub-graphs of graph 400; and
2. Eliminate from the set CANDIDATE GROUPINGS all graphs which break the rules (e.g., graphs which contain nodes whose lowest-cost connecting path exceeds the maximum allowed, graphs that contain any pair of nodes that are not connected by any path, and the like).
   Those skilled in the art will appreciate that this algorithm for generating CANDIDATE GROUPINGS may become computationally expensive when graph 400 has a large number of nodes. As a refinement, the inventors of the present application developed a more efficient algorithm by modifying a well-known algorithm that identifies connected components of a graph, where the component in the well-known algorithm may be analogized to the CANDIDATE GROUP. The modification may then include the following:
A) Allow multiple labels (rather than just one) for each edge because more than one CANDIDATE GROUP may overlap (that is, an edge may be in more than one CANDIDATE GROUP); and
B) Apply the rules to each component (CANDIDATE GROUP) as it is built to reduce or eliminate the construction of components (CANDIDATE GROUPs) that violate the rules.
   In part B above, if it is not possible to identify a CANDIDATE GROUP that violates the rules until construction is complete, step 2 in the algorithm (above) may be required. One will note that part A allows multiple labels, which is in contrast with the well-known component algorithm, which does not allow an edge to be in more than one component.

At block 822, for each graph CANDIDATE GROUP remaining in the set CANDIDATE GROUPINGS, create a unique GROUP node in graph 400 and add an edge from that node to each node in graph 400 that is also in CANDIDATE GROUP. FIG. 9C illustrates the addition of one such node (node 950) with edges (e.g., edges 951, 952, 953) added between nodes in the graph illustrated in FIGS. 9A-9B. FIG. 9D shows addition of more such nodes (e.g., node 960) and edges (e.g., 961, 962) for more groups. FIG. 9E illustrates a graph 908 after identifying and labeling each CANDIDATE GROUP. There are several related groupings (e.g., nodes 950, 960, 970, 980, 990, 995), each having one or more edges.

At block 806, after the related groupings have been built, process 800 may remove duplicate related grouping.

At block 808, materially duplicative related groupings may be merged.

After processing performed in process 800, a related grouping is added to the graph. FIG. 9C illustrates a related grouping 950 added to the nodes and edges displayed in graph 902 shown in FIG. 9B. FIG. 9D illustrates another related grouping 960 added to the nodes and edges displayed in graph 904 shown in FIG. 9C. While FIGS. 9C and 9D illustrates graphs with related groupings that appear to be isolated, that is not necessary the outcome. For example, FIG. 9E illustrates a graph having six related groupings 950, 960, 970, 980, 990, 995, where related grouping 970 and 960 are both inter-related in that they share some nodes (e.g., node 913). Once the related groupings are identified, the information regarding the related groupings is readily available for fulfilling requests based on specific criteria.

FIG. 10 is a display illustrating an exemplary user interface 1000 for requesting related groupings from the analysis engine based on specified criteria. The user interface 1000 may utilize any combination of well-known graphical control units for specifying the criteria and the criteria is dependent on the industry in which the research analysis system is implemented. For example, user interface 1000 displays a sliding bar, text input boxes for several criteria, as represented by reference numerals 1002-1012. Thus, a user may request a name for a specific business in UI element 1012, and specify other criteria, such as whether the results include church parcels, industrial parcels, office parcels, retail parcels. While user interface 1000 is one example of a user interface, any number of user interfaces can be designed for requesting the criteria to obtain the results from the processing as described in FIGS. 3-8.

FIG. 11 is a functional block diagram representing a computing device suitable for use in the research analysis system illustrated in FIG. 1. The computing device 1100 may include various types of computing systems. For example, in some embodiments, the computing device may be a desktop computing system executing a Web browser that may be used by a user to interactively obtain information from the analysis engine. In some other embodiments, the computing device may be a mobile computing device (e.g., a mobile phone, tablet, phablet). The computing device 1100 includes a processor unit 1102, a memory 1104, a storage medium 1106, an input mechanism 1108, and a display 1110. The processor unit 1102 advantageously includes a microprocessor or a special purpose processor such as a digital signal processor (DSP), but may in the alternative be any conventional form of processor, controller, microcontroller, state machine, or the like.

The processor unit 1102 is coupled to the memory 1104, which may be implemented as RAM memory holding software instructions that are executed by the processor unit 1102. These software instructions represent computer-readable instructions and computer executable instructions. In this embodiment, the software instructions stored in the memory 1104 include components (i.e., computer-readable components) for a research analysis engine 1120, a runtime environment or operating system 1122, and one or more other applications 1124. The memory 1104 may be on-board RAM, or the processor unit 1102 and the memory 1104 could collectively reside in an ASIC. In an alternate embodiment, the memory 1104 could be composed of firmware or flash memory.

The storage medium 1106 may be implemented as any nonvolatile memory, such as ROM memory, flash memory, or a magnetic disk drive, just to name a few. The storage medium 1106 could also be implemented as a combination of those or other technologies, such as a magnetic disk drive with cache (RAM) memory, or the like. In this particular embodiment, the storage medium 1106 is used to store data during periods when the computing device 1100 is powered off or without power. The storage medium 1106 may be used to store graphs, databases, models, and the like. It will be appreciated that the functional components may reside on a computer-readable medium and have computer-executable instructions for performing the acts and/or events of the various method of the claimed subject matter. The storage medium being on example of computer-readable medium.

The computing device 1100 also includes a communications module 1126 that enables bi-directional communication between the computing device 1100 and one or more other computing devices. The communications module 1126 may include components to enable RF or other wireless communications, such as a cellular telephone network, Bluetooth connection, wireless local area network, or perhaps a wireless wide area network. Alternatively, the communications module 1126 may include components to enable land line or hard wired network communications, such as an Ethernet connection, RJ-11 connection, universal serial bus connection, IEEE 1394 (Firewire) connection, or the like. These are intended as non-exhaustive lists and many other alternatives are possible.

The audio unit 1128 may be a component of the computing device 1100 that is configured to convert signals between analog and digital format. The audio unit 1128 is used by the computing device 1100 to output sound using a speaker 1130 and to receive input signals from a microphone 1132. The speaker 1132 could also be used to announce incoming calls.

A display 1110 is used to output data or information in a graphical form. The display could be any form of display technology, such as LCD, LED, OLED, or the like. The input mechanism 1108 includes keypad-style input mechanism and other commonly known input mechanisms. Alternatively, the input mechanism 1108 could be incorporated with the display 1110, such as the case with a touch-sensitive display device. Other alternatives too numerous to mention are also possible.

The principles and concepts will now be described with reference to sample processes that may be implemented by a computing device, such as the computing device illustrated in FIG. 11, in certain embodiments. The processes may be implemented using computer-executable instructions in software or firmware, but may also be implemented in other ways, such as with programmable logic, electronic circuitry, or the like. These processes are not to be interpreted as exclusive of other embodiments, but rather are provided as illustrative only.

### Illustrative Process

In one illustrative example, the processes illustrated in FIGS. 3-8 and described above will be used to describe how the research analysis system determines related properties owned by the same or related person. In this illustrative example, there is an imaginary property called Simpson Landings. The property may have been identified as a property of interest after a client drove by the property and observed the address. After identifying the property, the real estate professional may be interested in calling the owner of the property to find out whether the owner would be interested in selling the property. Using the user interface for the analysis system described above in FIG. 10, the real estate professional may type in either an address or a name (e.g., Simpson Landing) to obtain the desired information. As discussed above, because the research analysis system has created several graphs based on different relationships, a user can not only search for an owner's name or a physical address of a property, but can now also search using other categories, such as industrial properties larger than 500,000 square feet, all owners with holdings between $5 and $10 million, and the like. The analysis system, having already preprocessed the original data from the various data sources, can then look up a related grouping based on the criteria specified in the request by the user and provide the related grouping to the real estate professional as an interactive display (see related parcels shown in FIG. 2).

The following describes some of the processing performed by the research analysis system to create the related groupings using the original data. The original data includes property data from a county assessor's office and corporation data from a secretary of state's office. The property data includes building size, type, physical address, taxpayer name, taxpayer's address, and the like. The corporation data includes name of corporation, address, governing persons, agent, and the like. Table 1 illustrates a portion of the exemplary property data and Table 2 illustrates a portion of the exemplary corporation data. For convenience, only portions of a few records are illustrated to describe the processing by the research analysis system for this example. As one can imagine, the amount of data that is actually analyzed is substantial. However, by discussing the portions illustrated in Tables 1 and 2, an illustrative overview of the complex analysis that is performed by the research analysis system in determining related groupings is provided.

TABLE 1

| | |
|---|---|
| Property Data | |
| Property Name | Simpson Landing |
| Site Address | 1635 Tacoma Rd, Tacoma, WA 98403 |
| Taxpayer Name | Simpson Property 2 LLC |
| Mailing Address | 1635 Tacoma Rd, Tacoma, WA 98403 |
| Predominant Use | Industrial |
| Building Net Sq Ft | 526,980 |
| Year Built | 1997 |
| Sales Data | |
| | Recent Transfer |
| Sale Date | Mar. 1, 2014 |
| Sale Price | $0.00 |
| Instrument | Quit Claim |
| Buyer Name | Simpson Property 2 LLC |
| Seller Name | Simpson, John D. |
| | Previous Transfer |
| Sale Date | Jan. 31, 2013 |
| Sale Price | $10,000,000 |
| Sale Instrument | Statutory Warranty Deed |
| Buyer Name | Simpson, John D. |
| Seller Name | Equity Capital, LLC |

TABLE 2

| Property | Data |
|---|---|
| Entity Name | SIMPSON PROPERTY 2 LLC |
| Governing | John Simpson, Seattle, WA, Manager |
| Persons | |
| Agent | Generic Register Corp, 505 Union Ave, Olympia, WA |
| UBI Number | 602493106 |
| Category | LLC |
| Active/Inactive | Active |
| WA Filing Date | Feb. 13, 2014 |
| Expiration Date | Feb. 12, 2015 |

The research analysis system analyzes an exceptionally large amount of data. The data often exhibits varying word-order t (e.g., “Doe, John and Sally” versus “John Doe and Sally Doe”); has omissions (e.g., “Tuscany Partners LLC” versus “Tuscany Partners”); and contains misspellings, abbreviations (e.g., “LLC” versus “Limited Liability Corporation”), and the like. While people can readily determine some of these differences when viewing isolated incidents, their determinations may not always be correct depending on the differences. The present research analysis system views considerably more data and a relatively rare word such as “Tuscany” may appear multiple times and in various places such as a last name, a street address, within an entity name, or the like. Thus, by generating each datum as described above in FIGS. 4-7 and inputting each datum into the classification tool using a well trained model, the research analysis system can accurately determine a true meaning for the data and thus output a reliable result to include in a corresponding graph. The research analysis system may be supplied with a pre-defined list of abbreviations, substitutions, and omissions, which the research analysis system may use when determining data differences. By performing the processing as described in FIGS. 4-7 above, the analysis system may determine whether a name is correct or incorrect, and if it is incorrect, the name may be corrected and the corrected name may be added to the original data to denote the correction.

Each record may undergo an intra-record comparison where data in one record is compared with other data in the same record. For example, in a record from the property data of an assessor's office, a site address may be compared with a mailing address. If the two addresses match, which is common, mailing address may be ignored. If, on the other hand, site and mailing addresses differ, mailing address is likely related to the owner's location, and the analysis system retains that information. In addition, a comparison may occur between a taxpayer name and last buyer name listed for the property and. While in certain instances the two names will be the same, in some cases, the names may differ. If the two names differ, the research analysis system compares the taxpayer to the last recorded buyer to help determine the actual owner. For the corporation data, intra-record comparisons may be performed in various ways. One comparison may include checking if the agent matches a governing person. If two fields name the same person, the research analysis system may determine that the agent field may identify an active member, and therefore, may be more indicative of a relationship than a non-member agent with no governance role in the company. Knowing that that agent field is likely identifying an owner, rather than an unrelated party such as an attorney, the research analysis system may then glean additional information from the agent field, which often includes details not shown in the governing person field, such as a full address, a middle name, or other information. If the agent and governing person are determined to be the same person, but different addresses were identified in the respective fields, the analysis system retains that information for later processing.

In addition to intra-record comparisons, records from different data sources are compared. The cross-comparisons allow the analysis system to glean details that enrich the set of data. Both the intra-record comparisons and the cross-comparisons are performed as described above in the processing for FIGS. 4-7. Tables 1-4 will now be used to describe results of the processing. The taxpayer name (Simpson Property 2 LLC) listed in Table 1 is a direct match with the entity name (Simpson Property 2 LLC) listed in Table 2. Therefore, the analysis system determines that the taxpayer is controlled by that entity. Because the comparison of the mailing address and the site address in Table 1 are identical, the research analysis system determines that the mailing address is likely not an address for the person who can be contacted and can, therefore be disregarded as a contact address. The Sale Price is $0, which indicates that there likely was a transfer and not a sale of the property. The enumeration of the sale instrument yields a quit claim which confirms there was a transfer wherein the buyer is likely related to the seller and vice versa. Thus, the match between the taxpayer and the entity is strong since the names are the same. However, the research analysis system does an exhaustive comparison of each of the records in the multiple data sources to obtain a satisfactory accuracy by confirming other comparisons.

Because the analysis system creates several datum as described above while comparing intra-record data and cross-record data, the knowledge base of the classification tool is able to reliably predict the relationships being processed. For example, using the property sales data in Table 1, the research analysis system learns that Simpson Property 2 LLC was transferred by quit-claim from John D. Simpson. The research analysis system is trained to know that because the transfer is a quit-claim transfer and no money was exchanged, the same or a related person is likely involved on both sides of the transfer. In Table 2, John Simpson is shown as the governing person of Simpson Property 2 LLC. Using this information, the research analysis system can confirm that John Simpson is the owner, since at least two different comparisons confirmed the information. In addition, from the property data in Table 1, the research analysis system learns that the middle initial is “D”, which can then be made known when comparing the corporation data. While comparing other records, such as the corporation data in Table 3, the research analysis system will perform comparisons with entities with governing persons named “John Simpson”. However, because the research analysis system now knows the correct name is “John D. Simpson”, the analysis system disregards both John's Plumbing LLC and Simpson LLC as a related corporation to Simpson Property 2 LLC because the middle initials of the governing persons are incorrect. The research analysis system performs additional comparisons on Johnny's Marina LLC and Simpson Property 1 LLC to confirm that the listed governing person “John Simpson” is the same “John D. Simpson” who would then be related to the owner (same owner) of the Simpson Property 2 LLC. When the research analysis system compares data illustrated in Table 4, the system confirms that the buyer (Simpson Property LLC) is related to the buyer (Johnny's Marina LLC) because the sale instrument was a quit claim and price was $0.00. Thus, after these comparisons, an edge is created between Simpson Property 2 LLC and Johnny's Marina LLC and between Simpson Property 2 LLC and Simpson Property 1 LLC with the proper designation for the relationship, such as related owner.

TABLE 3

| Entity | Governing Person | Agent |
|---|---|---|
| SIMPSON | John D. Simpson, | Generic Register Corp, |
| PROPERTY | Seattle, WA | 505 Onion Ave, Olympia, WA |
| 2 LLC | | |
| John's Plumbing | John A. Simpson, | John A. Simpson, |
| LLC | Tacoma, WA | 2112 N 26th St, Tacoma |
| Simpson LLC | John Simpson, | John Q. Simpson, |
| | Seattle, WA | 34 Fourth Ave, Seattle |
| Johnny's Marina | John Simpson, | John D. Simpson, |
| LLC | Seattle, WA | 624 Sixth, Seattle, WA |
| Simpson Property | John Simpson, | Generic Register Corp, |
| 1 LLC | Seattle, WA | 505 Onion Ave, Olympia, WA |

TABLE 4

| | |
|---|---|
| Property Data | |
| Property Name | Lake Industrial |
| Site Address | 432 Jackson, Seattle, WA |
| Tax Payer Name | Simpson Property LLC |
| Mailing Address | 432 Jackson, Seattle, WA |
| Predominant Use | Industrial |
| Building Net Sq Ft | 24,900 |
| Year Built | 1980 |
| Sales Data | |
| Sale Date | Mar. 1, 2014 |
| Sale Price | $0.00 |
| Sale Instrument | Quit Claim |
| Buyer Name | Simpson Property LLC |
| Seller Name | Johnny's Marina LLC |

As each of these comparisons are performed, the corresponding part of the graph is updated. The new information is then made available for subsequent processing, thus enriching the data sets and allowing better predictions and confirmations. Any new information may then yield additional comparisons. For determining relationships, such as learning John D. Simpson's address is 624 Sixth, Seattle, Wash., the research analysis system may use the corporation data for the related item Johnny's Marina LLC in Table 3.

Once the analysis system pre-processes the data from the two or more data sources, the analysis system may then review the graphs and begin merging the data into related groupings based on a specific relationship. Because any type of relationship may be preprocessed by the research analysis system, the analysis system allows searches on additional categories using the original data. For example, a search may be performed for all owners with 200 or more apartment units, all owners with holdings between $5-$10 million.

By creating related groupings in accordance with the teaching of the present system, a new base unit may be created and made available for further analysis and/or sale. The related groupings are typically more meaningful than the original data and allow additional custom relationships to be created for optimizing certain research. In addition, because certain supplemental data from some data sources is prohibitively expensive, in terms of time and/or money, by requesting supplemental data based on the related groupings, fewer but more meaningful records of the supplemental data may be needed.

Although exemplary embodiments have been illustrated and described in this disclosure, it will be appreciated that various changes, both significant and insignificant, can be made to those embodiments without departing from the spirit and scope of the invention, which is set out in the claims which follow.

While the foregoing written description of the invention enables one of ordinary skill to make and use a research analysis system as described above, those of ordinary skill will understand and appreciate the existence of variations, combinations, and equivalents of the described embodiments, methods, and examples herein. While the above description describes a research analysis system implemented in the real estate industry, those skilled in the art will appreciate that the components can be readily modified and implemented for other industries in which subsets of related elements are derived from a large and diverse set of elements for the purpose of interactively analyzing and displaying the subsets of related elements for users.

For example, the research analysis system may be implemented in the retail sales and/or e-commerce industry. The retail sales industry will then have its own relationships that are analyzed, along with it own nodes, features, and transformations. For the retail sales implementation, the data source servers may provide product inventory, sales history, customer identification, and the like. Items in the inventory may be represented as the nodes in the graph. Relationships may include BOUGHT_TOGETHER, SUBSTITUTE_GOOD, and the like. The research analysis system may be configured to analyze the relationship BOUGHT_TOGETHER to generate an edge for each pair of items that are bought by the same customer or in the same basket. The edges may be annotated with the frequency with which the items were bought together in the same basket and in different baskets by the same customer. In addition, an edge labeled SUBSTITUTE_GOOD may be generated when pairs of inventory items are substitute goods. The graph may then be analyzed to determine the related groupings (e.g., sub-graphs), which represent an ACTIVITY that is a supposed quality of the shopper involved in the purchase of several inventory items. The research analysis system may then annotate inventory items with a weight indicating the frequency of occurrence of the inventory items in that ACTIVITY. Further, the research analysis system may post-process these ACTIVITY related groupings by further partitioning them into sub-graphs representing substitute goods. Each sub-graph may represent one class of substitutable goods. The sub-graphs may be further post-processed by the addition of known substitute goods of the same class that had not been included, perhaps because that specific inventory item is new or has not yet been sold with any other items in that specific ACTIVITY related grouping. The addition of these other inventory items may be constrained by the analyzed confidence in the relationship that identifies that item as a substitute for each of the items in fact identified in this ACTIVITY. For example, inventory items paper, glue, and wood glue may be identified as enjoying a weak SUBSTITUTE_GOOD relationship. In an identified ACTIVITY including inventory items wood, paper, and paper glue, the post-processing analysis may add the weak substitute good wood glue if the item paper glue carried a high weight in that ACTIVITY while in another ACTIVITY including inventory items paper, envelopes, sticky tape, and paper glue, the analysis engine may decline to add wood glue if the weight of paper glue was low. The output is a number of related groupings that identify items bought together. Further grouping them into classes whose members are substitute for one another and decorating the ACTIVITY nodes and edges with appropriate frequencies and weights. Having identified the ACTIVITY related groupings, in-progress shopping baskets may be compared with the ACTIVITY related grouping to identify which classes of item are missing. One or more inventory items from each missing class in the ACTIVITY may then be selected as a cross-sell candidate. This and other implementations of the research analysis system are envisioned.

Thus, the invention as claimed should therefore not be limited by the above described embodiments, methods, and examples, but by all embodiments and methods within the scope and spirit of the claimed invention.

The claimed invention is:

1. A research analysis system, the system comprising:
a memory for storing computer-readable instructions associated with an analysis tool; and
a processor programmed to execute the computer-readable instructions to enable the operation of the analysis tool, wherein when the computer-readable instructions are executed, the analysis tool is programmed to:
input original data from a plurality of data sources, wherein the original data includes at least one item that is of interest to an associated industry;
process the original data in manner to create a plurality of datum for input to a classification tool;
predict a plurality of relationships based on output from the classification tool;
predict a plurality of qualities based on output from the classification tool;
store the predicted plurality of relationships and the predicted plurality of qualities; and
generate at least one related grouping.

2. The system of claim 1, wherein creating a plurality of datum includes generating a feature and a corresponding value for each of the plurality of datum, wherein the feature includes a feature name that is mapped to a unique integer that corresponds to a dimension in the classification tool.

3. The system of claim 2, wherein the feature indicates a process to perform and the corresponding value represents a result from the processing.

4. The system of claim 2, wherein the feature indicates an element defined from the original data and the corresponding value represents a data value retrieved from the data source associated with the original data.

5. The system of claim 2, wherein the feature indicates an element defined polymorphically by the analysis tool and the corresponding value represents a data value computed by the analysis tool.

6. The system of claim 2, wherein the feature name remains consistent.

7. The system of claim 2, wherein the feature name is based on a naming convention derived from the original data.

8. The system of claim 1, wherein storing the predicted plurality of relationships is performed in a manner to enable creation of a graph of the predicted plurality of relationships, wherein the graph comprises a plurality of nodes and a plurality of edges, each node reflects the at least one item and each edge connecting two nodes reflects one predicted relationship between the connected nodes.

9. The system of claim 8, wherein the industry comprises a real estate industry and the at least one item includes a parcel or a corporation.

10. The system of claim 1, wherein generating at least one related grouping is based on at least one desired quality.

11. The system of claim 1, wherein generating at least one related grouping is based on at least one desired relationship.

12. The system of claim 11, wherein the desired relationship is based on at least one of the predicted plurality of relationships.

13. The system of claim 1, wherein processing the original data in a manner to create the plurality of datum for input to the classification tool includes processing at least one analytic relationship from the plurality of relationships and creating one datum associated with the processing of the at least one analytic relationship.

14. The system of claim 13, wherein processing the original data in a manner to create the plurality of datum for input to the classification tool further includes processing at least one analytic quality from the plurality of qualities and creating one datum associated with the processing of the at least one analytic quality.

15. The system of claim 14, further comprising processing the original data in a manner to create a plurality of datum for input to the classification tool comprises comparing the original data from one data source to each of the other data sources and formulating a name for the comparison using a naming convention.

16. The system of claim 1, wherein generating at least one related grouping based on the predicted plurality of relationships comprises traversing the graph to build a related grouping graph based on rules associated with the related grouping.

17. The system of claim 1, wherein in the analysis tool is further configured to create a model based on training data associated with one of the predicted relationships, wherein the model is used by the classification tool to generate the output.

18. A computer-implemented method for analyzing real estate information, the computer-implemented method comprising:
inputting original data from a plurality of data sources, wherein the original data includes at least one item that is of interest to an associated industry;
processing the original data in manner to create a plurality of datum for input to a classification tool;
predicting a plurality of relationships based on output from the classification tool;
predicting a plurality of qualities based on output from the classification tool;
storing the predicted plurality of relationships and the predicted plurality of qualities; and
generating at least one related grouping.

19. A computer-readable media storing computer-readable components executable by a computing device, the computer-readable components comprising:
a collection component configured to interact with a plurality of data sources to collect data;
a decomposition component configured to homogenize the data into a uniform composition;
a translation component configured to produce a plurality of datum, each datum comprising a feature and a corresponding value, wherein the feature includes a feature name that is mapped to a unique integer that corresponds to a dimension in a classification tool;
a prediction component configured to provide each datum as input to the classification tool, to receive prediction results from the classification tool, and to build at least one graph representing the results; and
a grouping component configured to traverse the at least one graph to create sub-graphs based on a desired relationship.

20. The computer-readable media storing computer-readable components of claim 18, further comprising a training component configured to create a model based on training data associated with one of a plurality of predicted relationships, wherein the model is used by the classification tool to generate the prediction results.
